(19) United States
(12) Patent Application Publication
(10) Pub. No.: US 2005/0111877 A1
(43) Pub. Date: May 26, 2005

(54) Fixture for mounting a sleeve member on a mandrel

(75) Inventors: Steven O. Cormier, West Henrietta, NY (US); Carol K. Dunn, Rochester, NY (US)

Correspondence Address: Lawrence P. Kessler;Patent Legal Staff, Eastman Kodak Company, 343 State Street, Rochester, NY, 14650-2201, US

(73) Assignee: Eastman Kodak Company

(21) Appl. No.: 10/965,412

(22) Filed: Oct. 14, 2004

Related U.S. Application Data
(60) Provisional application No. 60/523,619, filed on Nov. 20, 2003.

(51) Int. Cl. G03G 15/00; G03G 15/01

(52) U.S. Cl. 399/109; 399/302

(57) ABSTRACT

A fixture for a double-sleeved roller for assisting replacement of an inner sleeve member (ISM) thereon. The fixture attaches to a fixture-accepting configuration (FAC) including an end plate (EP), which FAC includes passageways for conveying jets of pressurized air to the ISM. The fixture includes a low-surface-energy-coated tubular member (TM) and a mating member (MM) cooperatively forming passageways for creating radially-directed air jets at the perimeter of the MM. The MM and EP cooperatively form another set of passageways for similarly creating air jets. The EP, MM, and TM each includes a cylindrical portion with adjoining tapered portion, the respective tapered portions mutually defined by a conical envelope. The tapered portion of the TM tapers into a cylindrical length merging into a narrowing portion. In all, the air jets are formed from a common source of pressurized air.

### CROSS-REFERENCE TO RELATED APPLICATIONS

Reference is made to the following commonly assigned application, the disclosure of which is incorporated herein by reference:
U.S. patent application Ser. No. ______, filed on even filing date herewith, by Steven O. Cormier, et al., entitled, “DOUBLE-SLEEVED ELECTROSTATOGRAPHIC ROLLER”;

### FIELD OF THE INVENTION

The invention relates to electrostatography and to electrostatographic roller apparatus, and in particular to a fixture and method for use to remove and replace an inner sleeve member of a double-sleeved roller.

### BACKGROUND OF THE INVENTION

Usage of compliant rollers in electrophotographic apparatus is well known, which compliant rollers may incorporate a removable sleeve member mounted concentrically around a mandrel. Single-sleeved and double-sleeved compliant rollers have been disclosed, e.g., sleeved imaging rollers, sleeved intermediate transfer rollers, and sleeved rollers for use in a fusing station. In an electrostatographic machine, a toner image can be formed on a sleeved imaging roller, transferred in a first transfer operation from the imaging roller to a sleeved intermediate transfer roller, and subsequently transferred in a second transfer operation from the intermediate transfer roller to a receiver member (e.g., paper). The toner image on the receiver member is subsequently fixed thereon in a fusing station.

The use of a removable endless belt or tubular type of blanket on an intermediate transfer roller has long been practiced in the offset lithographic printing industry. As disclosed, for example, in the Julian patent (U.S. Pat. No. 4,144,812) an intermediate lithographic roller has a portion having a slightly smaller diameter than the main body of the roller, such that a blanket member may be slid along this narrower portion until it reaches a location where a set of holes located in the roller allow a fluid under pressure, e.g., pressurized air, to pass through the holes, thereby stretching the blanket member and allowing the entire blanket member to be slid onto the main body of the roller. After the blanket is located in a suitable position, the source of pressurized air or fluid under pressure is turned off, thereby allowing the blanket member to relax to a condition of smaller strain, such strain being sufficient to cause the blanket member to snugly embrace the roller. The Gelinas patent (U.S. Pat. No. 5,894,796) discloses that the tubular blanket may be made of materials including rubbers and plastics and may be reinforced by an inner layer of aluminum or other metal.

An intermediate transfer roller having a rigid core and a removable, replaceable intermediate transfer blanket has been disclosed by Landa, et al., in U.S. Pat. No. 5,335,054, and by Gazit, et al., in U.S. Pat. No. 5,745,829, whereby the intermediate transfer blanket is fixedly and replaceably secured and attached to the core. The intermediate transfer blanket includes a substantially rectangular sheet mechanically held to the core by grippers. The core (or drum) has recesses where the grippers are located. It is disadvantageous that the entire circumference of the intermediate transfer drum cannot be utilized for transfer because the blanket does not form a continuous covering of the core surface. Moreover, particulate contamination tends to collect in the unavoidable gap between the ends of the blanket.

An electrostatographic imaging member in the form of a removable replaceable endless imaging belt on a rigid roller is disclosed by the Yu, et al. patent (U.S. Pat. No. 5,415,961). The electrostatographic imaging member is placed on the rigid roller and removed from the rigid roller by stretching the endless imaging belt with a pressurized fluid.

The Mammino, et al. patents (U.S. Pat. Nos. 5,298,956 and 5,409,557) disclose a reinforced seamless intermediate transfer member that may be in the shape of a belt, sleeve, tube or roll and including a reinforcing member in an endless configuration having filler material and electrical property regulating material on, around or embedded in the reinforcing member.

The Chowdry, et al. patent (U.S. Pat. No. 6,605,399) discloses a sleeved compliant primary image-forming roller and a method of making such a roller. The sleeve is a photoconductive member, the sleeve resting on a compliant layer coated on a core member. This has certain advantages over U.S. Pat. No. 5,715,505 and U.S. Pat. No. 5,828,931, in that the coatings on the roller are made more reliably and more cheaply, and also in that the photoconductive sleeve may be readily removed and replaced when at the end of its useful life, thereby lowering cost and reducing downtime. The Chowdry, et al. patent (U.S. Pat. No. 6,605,399) also includes an advantage over U.S. Pat. No. 5,415,961 by providing a core member coated by a thick compliant layer over which the sleeve member is placeable and removable. However, in certain embodiments of this Chowdry, et al. patent, the rigid core member is electrically biased to effect transfer of toner, and because the electrical properties of the compliant layer coated on the core member alter with age, the compliant layer has a finite lifetime requiring expensive periodic replacement of the coated core member. Moreover, the compliant layer is disadvantageously subject to damage when removing or replacing a sleeve member, and such damage may necessitate recoating or replacing the costly core member.

The Shifley, et al. patents (U.S. Pat. Nos. 6,259,873, 6,263,177 and 6,484,002) disclose apparatus including a roller (such as a photoconductive roller or an intermediate transfer roller) which roller has a removable replaceable surface or sleeve, and which roller is supported at one end in cantilevered fashion during sleeve removal or replacement via the other end of the roller. For operation of the roller, the roller is supported at both ends. A disconnectable supportive member is provided that can be disengaged and moved away from the roller so as to provide a free end for purpose of sleeve removal or replacement. This supportive member is moved back so as to engage and support the roller for operation.

The Cormier, et al. patent (U.S. Pat. No. 6,394,943) describes an image transfer drum inclusive of a mandrel having an air bearing to facilitate loading and removal of a resilient sleeve. The air bearing is provided with a pair of cooperating plates one of which is scored with equally spaced and radially extending grooves. When urged together, the plates define a central air chamber and a plurality of radially-extending passages serving to direct pressurized air radially from one end of the mandrel, at which end the sleeve can be removed and replaced. The pressurized air is conveyed to the central chamber via a pipe passing into the mandrel at the other end of the mandrel, at which other end the mandrel is supported in cantilever fashion during removal or replacement of a sleeve.

Advantage over the Chowdry, et al. patent (U.S. Pat. No. 6,605,399) and the Cormier, et al. patent (U.S. Pat. No. 6,394,943) is obtained by providing an electrostatographic double-sleeved roller, as disclosed in the Chowdry, et al. patent (U.S. Pat. No. 6,377,772). Such a type of double-sleeved roller (DSR) can be useful for a number of applications in an electrostatographic machine, for example as a primary image-forming member or as an intermediate transfer member. The DSR includes a cylindrical rigid core member, a replaceable removable multilayer inner sleeve member (ISM) in the shape of an endless tubular belt including at least one compliant layer (e.g., made of a polyurethane) such that the ISM surrounds and nonadhesively intimately contacts the core member, and a replaceable removable multilayer outer sleeve member (OSM) in the shape of an endless tubular belt including at least one synthetic layer such that the OSM surrounds and nonadhesively intimately contacts the ISM. The synthetic layer may include, for example, a plastic, a polymer, a copolymer, an elastomer, a foam, a photoconductive material, a material having filler particles, a material including two or more phases, or a material reinforced with fibers. Because of the double-sleeve construction, an accurately dimensioned core member can have a long life without need of replacement. Moreover, the core member can advantageously remain fixed to the electrostatographic apparatus in which it is mounted when a sleeve member is replaced, and in a preferred embodiment either or both OSM and ISM are removable from the same end of the roller. A DSR as disclosed in the Chowdry, et al. patent (U.S. Pat. No. 6,377,772) has an extra advantage in that a stiffening layer can be included as an exterior outer surface of an ISM or more preferably as an exterior inner surface of an OSM, thereby avoiding certain coating complications and facilitating mounting and demounting of the sleeves. Additionally, overall operating costs are reduced, inasmuch as either sleeve may be replaced without replacing the other, or else the inner and outer sleeves may be replaced with differing frequencies. Thus an inner or outer sleeve member can easily and independently be replaced on account of wear or damage, or replaced when at the end of a predetermined operational life. An expensive, finely toleranced core member can thereby be retained for long operational usage with many generations of sleeve members.

The Aslam, et al. patents (U.S. Pat. Nos. 6,393,249 and 6,567,641) disclose double-sleeved rollers for use in a fusing station of an electrostatographic machine, e.g., as fuser rollers, as pressure rollers, or both.

An inner sleeve member (ISM) employed according to the Chowdry, et al. patent (U.S. Pat. No. 6,377,772) includes a flexible high-modulus tubular band, e.g., as a strengthening band or backing layer concentric with and supporting an adhered compliant layer. With the outer sleeve member (OSM) removed, this backing layer facilitates handling of the ISM during its removal or replacement using a pressurized air technique akin to that disclosed in the Julian patent (U.S. Pat. No. 4,144,812). However, to manufacture such a reinforced ISM generally requires a costly coating process. Thus there is a need to reduce manufacturing expense. One solution is to utilize a relatively cheap, non-reinforced, compliant ISM, i.e., an ISM having no high-modulus band or backing layer, such as is disclosed below for inclusion in the present invention. However, a non-reinforced relatively stretchable ISM (not contemplated in the Chowdry, et al. patent (U.S. Pat. No. 6,377,772)) has a propensity to exhibit edge disturbance when the pressurized air technique is used to expand and axially slide the OSM over the ISM (prior to removing the ISM).

A specialized mandrel, for securely supporting a non-reinforced compliant ISM during mounting and demounting of an outer sleeve member of a double-sleeved roller, is included in a double-sleeved roller (DSR) which is disclosed in the Cormier, et al. patent application (U.S. patent application Ser. No. 10/______ filed with the U.S. Patent and Trademark Office on even date herewith) incorporated herein by reference. This DSR includes: a mandrel having a disconnectable end connected to three termination plates having specified outer shapes; a replaceable inner sleeve member (ISM) mounted on the mandrel; and, a replaceable outer sleeve member (OSM) with the OSM surrounding the ISM. The mandrel is adapted to support a non-reinforced ISM, the mandrel including the termination plates joined together so as to define two sets of channels for selectively conveying pressurized air to either OSM or ISM for radial expansion thereof. The outer shape of each termination plate includes a cylindrical portion adjoining a tapered portion. A preferred embodiment includes a single source pipe for providing the pressurized air to the two sets of channels. For removal and/or replacement of a sleeve member, a removable support member is moved away from the disconnectable end of the roller while the other end of the roller continues to be supported in cantilever fashion.

In relation to the double-sleeved roller disclosed in the co-filed Cormier et al. patent application cited above, it has been found by the inventors that removal from and/or replacement of an inner sleeve member from such a mandrel is problematical because of the way the inner sleeve member grips a tapered surface included in the mandrel, and also because the ISM is considerably stretched on the mandrel. Thus there remains a need to provide a device for easing the air-pressure-assisted sliding of inner sleeve members off, or on, such a mandrel. A removable fixture for providing such assistance, which fixture is attachable at the disconnectable end of the roller, is disclosed in the present invention.

### SUMMARY OF THE INVENTION

A sleeve-replacement fixture is disclosed for employment in aiding removal and replacement of an inner sleeve member (ISM) of a double-sleeved roller (DSR). The DSR includes the ISM mounted on a mandrel and a replaceable outer sleeve member (OSM) surrounding the ISM. The mandrel, adapted to support a non-reinforced ISM, has a disconnectable end supported by a removable support member, at which disconnectable end are connected three termination plates having specified outer shapes: an inner termination plate, a middle termination plate, and an outer termination plate. Each of these outer shapes includes a cylindrical portion adjoining a conically tapered portion. The termination plates are joined together and mutually cooperate so as to form two internal chambers and two corresponding pluralities of radial channels for selectively conveying pressurized air from the respective internal chamber to the OSM or ISM for radial expansion thereof, with the internal chambers connectable to a single source of pressurized air. The two internal chambers of a fully-assembled DSR are mutually connectable via a pipe. This pipe is closed by a reversible blockage during operational use of the DSR and also during replacement or removal of the OSM. The blockage is removed and the pipe thereby opened in conjunction with use of the sleeve-replacement fixture of the invention.

The sleeve-replacement fixture (SRF) is a device temporarily attachable to the middle termination plate in lieu of the outer termination plate, with one of the pluralities of radial channels of the mandrel thereby left intact, i.e., those channels which lead to the underside of the inner sleeve member. The SRF is installed after partial disassembly of the DSR, i.e., after the removable support member, the OSM, the outer termination plate, and the blockage to the channels leading to the ISM are removed at the disconnectable end of the roller, with the other end of the roller supported in cantilever fashion.

In a preferred embodiment, the sleeve-replacement fixture (SRF) has a generally cylindrical symmetry, the SRF including two main members, a generally tubular member and a mating member (MM) in the form of a plate attached thereto, with each member having a specified outer shape. The tubular member has an end surface in contact with one side of the MM, with the other side of the MM for attachment to the middle termination plate of the mandrel. Attachment of the sleeve-replacement fixture causes the MM to cooperate with the outward surface of the middle termination plate so as to form an annular chamber and a plurality of radially-extending air passageways connecting this annular chamber and the perimeter of the MM, the annular chamber being connectable to a source of pressurized air, whereby a plurality of radially-directed air streams are created at the perimeter of the MM when pressurized air is introduced into the annular chamber. The MM also cooperates with the end surface of the tubular member so as to form an additional plurality of radially-extending air passageways to the perimeter of the MM. These two pluralities of radially-extending air passageways are mutually connected, in one-to-one fashion, by a plurality of bores passing through the MM. The bores are for transmitting pressurized air (i.e., from the annular chamber) to the plurality of radially-extending air passageways formed by the MM and the tubular member, thereby creating an additional plurality of radially-directed air streams. Installation of the SRF of the invention thus gives rise to a total of three sets of radial channels for conveying, from a single source pipe, pressurized air so as to produce three corresponding pluralities of radially-directed air streams to assist removal and replacement of an inner sleeve member.

A key feature of the invention relates to the specified outer shapes of the tubular member, the mating member (MM) of the SRF assembly, and the outer shape of the middle termination plate (MTP) to which the SRF attaches. Each of these three outer shapes includes an axially thin cylindrical portion and an adjoining conically tapered portion having a respective taper angle, and in the preferred embodiment, the taper angles of tubular member, the MM, and the MTP are all the same such that the surfaces of the three conically tapered portions are mutually defined by a conical envelope. Moreover, the tapered portion of the tubular member tapers into a cylindrical length of the tubular member, which cylindrical length merges into an adjacent continuously narrowing portion.

The invention, and its objects and advantages, will become more apparent in the detailed description of the preferred embodiment presented below.

### BRIEF DESCRIPTION OF THE DRAWINGS

In the detailed description of the preferred embodiments of the invention presented below, reference is made to the accompanying drawings, in some of which the relative relationships of the various components are illustrated, it being understood that orientation of the apparatus may be modified. For clarity of understanding of the drawings, some elements have been removed, and relative proportions depicted or indicated of the various elements of which disclosed members are composed may not be representative of the actual proportions, and some of the dimensions may be selectively exaggerated.

FIG. 1 schematically illustrates a general mandrel assembly used in conjunction with the invention, the mandrel assembly including a mandrel and mandrel-supporting members for inclusion in a double-sleeved electrostatographic roller, in which double-sleeved roller the mandrel supports a replaceable inner sleeve member and a replaceable outer sleeve member mounted around the inner sleeve member (sleeve members not shown);

FIG. 2A shows in schematic cross-section a side view of a portion of the mandrel included in the assembly of FIG. 1, with inner and outer sleeve members mounted on the mandrel, the mandrel being inclusive of an outer termination plate, a middle termination plate, an inner termination plate and a sleeve-supporting member, the three termination plates defining two sets of radial channels for the conveyance of pressurized air to the undersides of the inner and outer sleeve members respectively;

FIG. 2B shows in schematic cross-section a side view of a portion of a fixture-accepting configuration for use with the invention, the fixture-accepting configuration derived from a partial disassembly of the apparatus of FIG. 2A;

FIG. 3 illustrates a cutaway view and section of a portion of a specific embodiment of a double-sleeved roller preferred for use in conjunction with the invention, showing a securely mounted inner sleeve member and a partially-mounted outer sleeve member;

FIG. 4 shows in cross-section a side view of a portion of a preferred fixture-accepting configuration derived from a partial disassembly of the roller portion of FIG. 3;

FIG. 5 shows an exploded view (in perspective from below) of a sleeve-replacement fixture of the invention, the sleeve-replacement fixture including a tubular member, a mating member for mating to the preferred fixture-accepting configuration of FIG. 4, and an O-ring between the tubular member and the mating member;

FIG. 6 shows a side view of the assembled sleeve-replacement fixture of FIG. 5;

FIG. 7A shows a cut-away section and three-dimensional view of the sleeve-replacement fixture of FIG. 5;

FIG. 7B is an enlarged view of the portion of the sleeve-replacement fixture and mating member shown in the dashed-line circle of FIG. 7A;

FIG. 8 illustrates the outward face of the mating member included in the sleeve-replacement fixture of the invention (also see FIG. 5);

FIG. 9 illustrates the inward face of the mating member of FIG. 8;

FIG. 10 shows, in a side outside view, a structure including a portion of the sleeve-replacement fixture of the invention when installed on the fixture-accepting configuration portion illustrated in FIG. 4; and

FIG. 11 is an axially directed view of the structure of FIG. 10, showing a staggering between air jets that can be formed by the two aligned sets of radially-directed air passageways formed by the sleeve-replacement fixture of the invention illustrated in FIG. 6 and the air jets that can be formed by a plurality of radial channels included in the fixture-accepting configuration portion illustrated in FIG. 4.

### DETAILED DESCRIPTION OF THE PREFERRED EMBODIMENTS

The subject invention discloses a novel sleeve-replacement fixture (SRF) for aiding replacement of an inner sleeve member (ISM) of a double-sleeved roller (DSR). The invention, used in conjunction with a partly disassembled DSR, is briefly described in the next paragraph and then described in detail with accompanying figures.

The DSR for use in conjunction with the invention is inclusive of a mandrel, with the ISM gripping the mandrel and an outer sleeve member (OSM) grippingly surrounding the ISM. The DSR has two ends including a disconnectable end supported by a removable support member. The disconnectable end includes a shaft member and a bearing mounted on the shaft member. The mandrel is inclusive of a sleeve-supporting member rotatably supported at the other end of the two ends of the DSR, with the sleeve-supporting member attached to an inner termination plate (ITP) at the disconnectable end. The ITP is also attached to a middle termination plate (MTP) with the MTP having an outer surface attached to an outer termination plate (OTP), the OTP of the DSR being operationally connected to the removable support member. The MTP cooperates with the ITP to form a plurality of radial channels therebetween which are connectable to a source of pressurized air, the radial channels terminating peripherally at a plurality of channel endings where pressurized air can be used to produce radial expansion of the ISM. In a fully assembled DSR, the plurality of radial channels is blocked from the source of pressurized air by a reversible blockage, which blockage is removed when the sleeve-replacement fixture of the invention is in use. The SRF is attached to a fixture-accepting configuration (FAC) derived from the DSR. The FAC is obtained by partially disassembling the DSR via the steps of (a) removing the removable support member from the disconnectable end, (b) removing the OSM, (c) removing the OTP, and (d) unblocking the blockage. The FAC includes (i) the sleeve-supporting member supported in cantilever fashion at the other end of the two ends, (ii) the ITP, (iii) the MTP which is equivalently called the end plate of the FAC, and (iv) the ISM. The sleeve-replacement fixture (SRF) includes a tubular member (TM) joined to a mating member (MM), with the MM for attachment to the end plate of the FAC. The TM and the MM cooperatively form a first set of radially-directed air passageways. With the sleeve-replacement fixture installed such that the MM is attached to the end plate of the FAC, the MM and the end plate cooperatively create a second set of radially-directed air passageways connectable to the source of pressurized air. The first set of radially-directed air passageways communicate, in one-to-one fashion, with the second set of radially-directed air passageways via a plurality of bores through the MM. With the source of pressurized air connected to the first and second sets of radially-directed air passageways, as well as to the plurality of radial channels formed by the ITP and the end plate (middle termination plate), three sets of radially-directed air jets are formed so that the inner sleeve member is slidably movable over the sleeve-replacement fixture and off the fixture-accepting configuration. Similarly, the three sets of radially-directed air jets are employed when mounting an ISM on a mandrel having a bare sleeve-supporting member, i.e., by slidably moving the ISM over the SRF to an operational position on the sleeve-supporting member. It is an important feature of the invention that the TM and the MM of the SRF are each provided with a taper which, in conjunction with tapers on each of the end plate and ITP of the FAC, promote the sliding of an inner sleeve member on or off the mandrel.

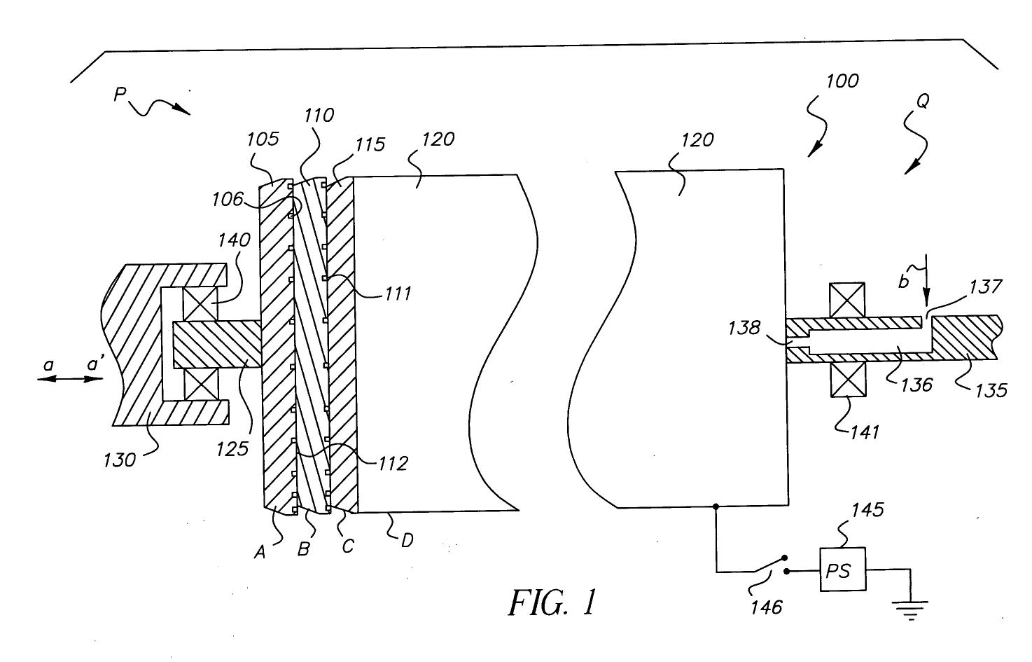

Turning now to FIG. 1, a generalized mandrel assembly 100 is depicted, the mandrel assembly including a mandrel and mandrel-supporting members. The mandrel is included in a double-sleeved electrostatographic roller, the mandrel for operationally supporting or holding a compliant removable inner sleeve member (ISM) and a removable outer sleeve member (OSM), with the outer sleeve member mounted around the inner sleeve member. The mandrel of assembly 100 includes inner termination plate 105, middle termination plate 110, outer termination plate 115, and sleeve-supporting member 120 (ISM and OSM not shown). Mandrel assembly 100 has a first end (indicated by P) and a second end (indicated by Q). The mandrel is operationally supported at end P by a disconnectable supporting member 130. Member 130 is reversibly movable away from the mandrel (as indicated by the double-headed arrow, a . . . a′) in manner such that end Q remains connected, in cantilever fashion via axle member 135, to a frame member of the electrostatographic machine (frame member not shown). Outward and inward directions, defined at end P, point respectively away from, and toward, end P, i.e., respectively toward the left and right in FIG. 1.

Sleeve-supporting member 120, labeled D, is rotatable about the roller axis and preferably has a predetermined outer diameter.

Inner termination plate (ITP) 115, labeled C, is operationally secured to the sleeve-supporting member 120.

Middle termination plate (MTP) 110, labeled B, is connected to the inner termination plate (ITP) 115. A preferably planar inward surface of the MTP has formed therein a plurality of radially-extending grooves extending from an annular recess to a perimeter of the MTP. This inward surface of the MTP and a preferably flat outward surface of the ITP cooperate to form an annular chamber and a plurality of radially-extending channels connecting the annular chamber and the perimeter of the MTP. The annular chamber is connectable to a source of pressurized air during removal or replacement of an inner sleeve member (ISM), whereby a plurality of radially-directed air streams or jets can be created at the perimeter of the MTP and at the inner surface of the ISM when pressurized air is introduced into the annular chamber. The plurality of radially-extending channels are ended by a corresponding plurality of terminations or openings, e.g., channel ending 111, from which the plurality of radially-directed air streams can be directed as described. Preferably the openings such as opening 111 are equally spaced circumferentially.

Outer termination plate (OTP) 105, labeled A, is operationally connected to the middle termination plate (MTP) 110, and is reversibly removable therefrom. A planar inward surface of the OTP has formed therein a plurality of radially-extending grooves extending from an annular recess to a perimeter of the OTP. This inward surface of the OTP and a flat outward surface of the MTP cooperate to form a second annular chamber and a second plurality of radially-extending channels connecting the second annular chamber and the perimeter of the OTP. The second annular chamber is connectable to the source of pressurized air, whereby a second plurality of radially-directed air streams or jets are created at the perimeter of the OTP and at the inner surface of the OSM when pressurized air is introduced into the second annular chamber. The second plurality of radially-extending channels are ended by a corresponding plurality of terminations or openings, e.g., channel end 106, from which the second plurality of radially-directed air streams can be directed as described. Preferably the openings such as opening 106 are equally spaced circumferentially.

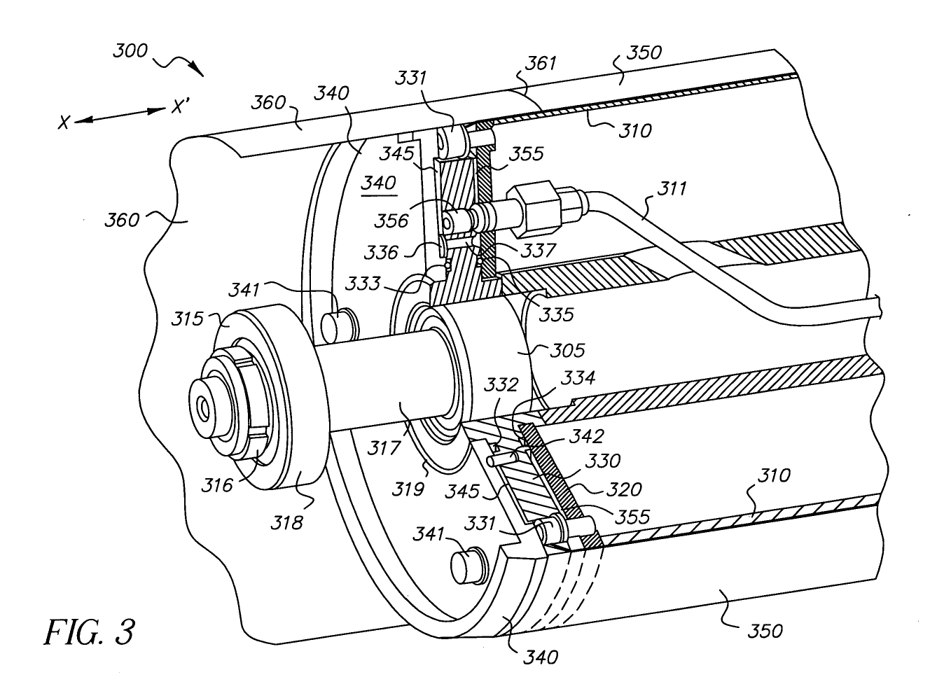

With further reference to FIG. 1, mandrel assembly 100 includes axle members 125 and 135 for supporting the double-sleeved roller, with axle member 125 rotatable in a bearing 140 and axle member 135 rotatable in a bearing 141, with bearing 141 anchored to a support member such as a frame member (frame member not shown). Bearing 140 is operationally supported by the disconnectable support member 130, and preferably bearing 140 and its housing (details of bearing 140 not illustrated) remain attached to axle member 125 when there is occasion to change or replace a sleeve member, i.e., when disconnectable support member 130 has been moved away in the outward direction. Outer termination plate 105 has a central hole (see FIG. 3) such that in a condition with the disconnectable support member 130 disconnected and moved away, plate 105 can be disconnected from the middle termination plate 110 and translated over the housing of bearing 140 and away from axle member 125.

As indicated in FIG. 1, a power supply (PS) 145 activatable by a switch 146 can be used to apply an electrical bias to the mandrel of assembly 100, e.g., to the sleeve-supporting member 120, as illustrated. So as to be able to apply an appropriate voltage, the mandrel must be electrically isolated from the electrostatographic machine, preferably by an insulating material. Preferably, this insulating material separates each of the axle members 125 and 135 from the mandrel and so prevents electrical contact therebetween.

Pressurized air can be introduced (see arrow b) via an entry port 137 leading into an interior volume 136 located inside axle member 135, and from thence into a pipe 138 and ultimately to the annular chambers described above.

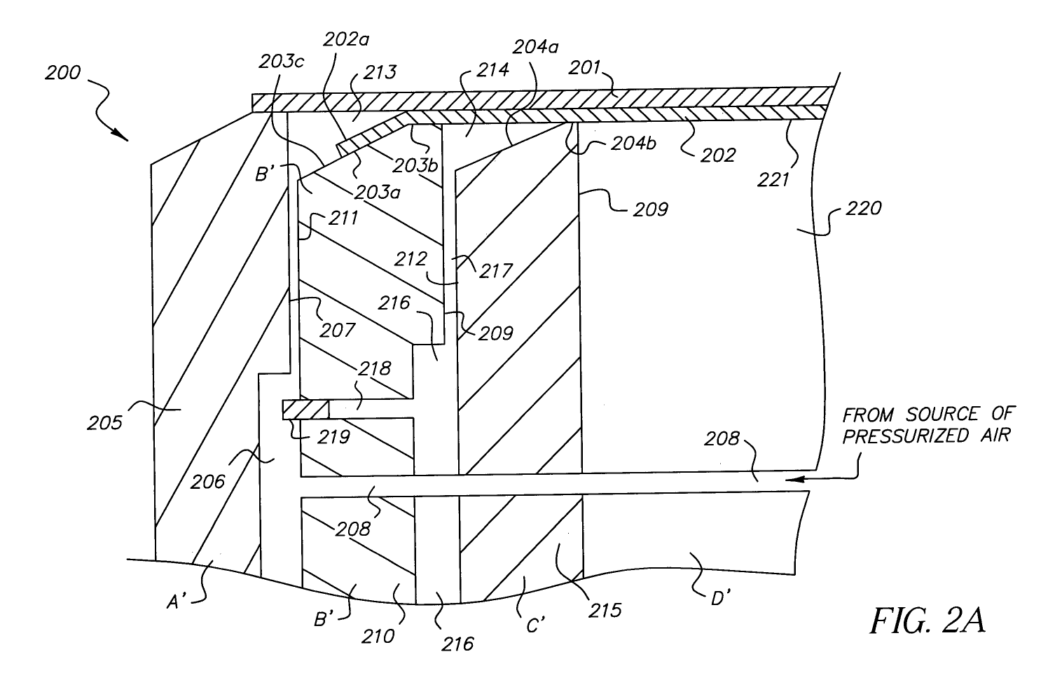

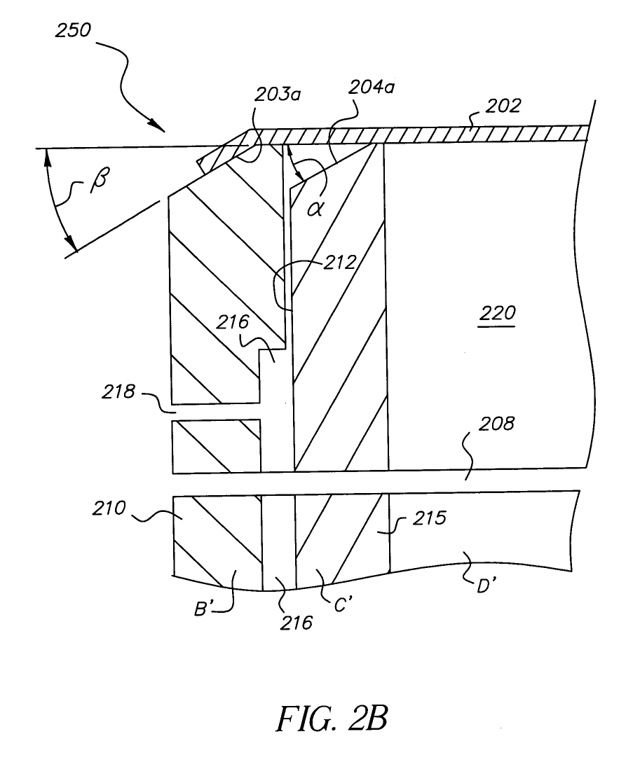

In a condition with the mandrel of assembly 100 having mounted thereon both inner and outer sleeve members, pipe 138 leads directly through a hollow interior portion of sleeve-supporting member 120 to the second annular chamber formed by the contact between members A and B and from thence to the second plurality of openings exemplified by opening 106 so as to provide the above-described second plurality of radially-directed air streams for removal and/or replacement of an outer sleeve member. In this condition, shown in FIG. 2A, the annular chamber (formed by members B′ and C′) is prevented from connecting with the source of pressurized air by a removable blockage (not illustrated in FIG. 1, see FIG. 2A).

FIG. 2A shows in schematic cross-section a side view of a generalized portion 200 of a double-sleeved roller used in conjunction with the invention. Roller portion 200 is inclusive of four axially joined members, A′(205), B′(210), C′(215), and D′(220), corresponding respectively to members A, B, C, and D of FIG. 1. As described above, members A′, B′, and C′ define two sets of radial channels for the conveyance of pressurized air to the undersides of an inner sleeve member (ISM) 202 and an outer sleeve member (OSM) 201. A pipe 208 (corresponding to pipe 138 of FIG. 1), connectable to a source of pressurized air, is provided for carrying pressurized air through the interior of sleeve-supporting member 220 into an interior chamber 206 of roller portion 200. Interior chamber 206, created by cooperation of members A′ and B′, has a plurality of radial channels or connections, e.g., connection 207, leading to an enclosed annular volume 213, defined by the underside of OSM 201, by the covered and uncovered portions of sloping surface 203a of the middle termination plate (MTP) 210, and by a flat inward facing surface of outer termination plate (OTP) 205. Similarly, an interior chamber 216 is created by cooperation of members B′ and C′. There is a plurality of at least eight equivalent connections, e.g., connection 217, leading from interior chamber 216 to an enclosed annular volume 214. The volume 214 is defined by the underside of ISM 202, by the sloping surface 204a of the inner termination plate (ITP) 215, and by a preferably flat inward facing surface of MTP 210. A pipe 218 connects interior chambers 206 and 216, with pipe blocked as shown by any suitable blockage or device 219. Device 219 can for example be a gating device, a flap, a valve, a cap, a plug, and so forth. Preferably device 219 is a removable plug made of a deformable material such as a rubber. With device 219 blocking tube 218 as shown, an admission of pressurized air into chamber 206 and from thence into annular volume 213 will expand outer sleeve member 201, thus permitting removal of OSM 201 from the roller portion 200 by sliding OSM 201 over the outer termination plate, A′. As shown in FIG. 2A, OSM 201 grips ISM 202 and a cylindrically-shaped portion of the plate, A′. The inner sleeve member (ISM) 202 not only grips sleeve-supporting member 220, but also grips a cylindrically-shaped portion 204b of ITP 215, as well as a cylindrically-shaped portion 203b of MTP 210. ITP 215 and MTP 210 each includes a portion with a tapered outer shape having a sloping surface, namely surfaces 204a and 203a, respectively. Preferably, the tapered outer shapes of surfaces 204a and 203a have the form of conical tapers. A portion 202a of ISM 202 overlaps and snugly grips a certain length of the sloping surface 203a of the tapered outer shape of member B′, leaving a part of sloping surface 203a not covered by ISM 202. The uncovered length, 203c, is preferably in a range of approximately between 0.5-3 mm, and more preferably approximately 1 mm. The total length of the overlapped and non-overlapped portions of surface 203a (and measured thereon) preferably has magnitude greater than about 9 mm. Moreover, the outer diameters of the cylindrically-shaped portions 203b of member B′ and 204b of member C′ are substantially equal to one another. Also, the outer diameter of cylindrical surface 221 of the sleeve-supporting member 220 is substantially the same as the outer diameter of the cylindrically-shaped portion 204b of member 215.

The compliant sleeve member 202 is a non-reinforced member. Specifically, inner sleeve member (ISM 202) has no backing layer. ISM 202 is stretchably deformable and preferably grips surface 221 of sleeve-supporting member 220 with an interference of approximately 10 mm±5 mm. It is noteworthy that such a large interference ensures critical conformance of ISM 202 with the outer shape of the middle termination plate B′. (Interference is defined herein as an increase of inner diameter of the unstretched sleeve member after stretchably mounting the sleeve member so as to grip the underlying member, the underlying member having an outer diameter larger than the inner diameter of the unstretched sleeve member). ISM 202, which may include a thin flexible overcoat, preferably has a thickness in a range of approximately between 0.2 mm and 14 mm, and more preferably, has a thickness of 0.500 mm±0.005 mm.

The portion 204b of plate C′ having a cylindrical outer shape has an axial length which is not critical, typically less than about 2 mm. Axial thickness of ITP 115 as measured between flat outer face 212 and the flat inner face 209 is not critical, typically about 7±3 mm. Similarly, the portion 203b of plate B′ having a cylindrical outer shape has an axial length preferably in a range of approximately between 2 mm-6 mm. Axial thickness of MTP 210 as measured between flat outer face 211 and flat inner face 222 is preferably in a range of approximately between 12 mm-16 mm.

To replace inner sleeve member 202, the following preparatory sequential steps are employed: the disconnectable support member (not shown in FIG. 2A) such as support member 130 of FIG. 1 is disconnected and moved away, the source of pressurized air for supplying pipe 208 is turned on so as to expand OSM 201, the OSM 201 is removed, the source of pressurized air is turned off, the outer termination plate A′ is removed, and the blockage 219 is removed so that a connection can be made between chambers 206 and 216, which connection is made via installation of the sleeve-replacement fixture of the invention. After the above preparatory steps have been completed, the roller 200 has been partially disassembled, resulting in a fixture-accepting configuration (FAC).

FIG. 2B shows a portion 250 of a preferred fixture-accepting configuration (FAC) derived from the roller portion 200. In FIG. 2B, the various elements identified by numerals correspond entirely to similar elements shown in FIG. 2A. The conically tapered surface portion 204a is defined by the illustrated taper angle, α, and the conically tapered surface portion 203a is defined by the illustrated taper angle, β. Each of these taper angles preferably is in a range of approximately between 5°-45°. Typically, each of these taper angles is about 15 degrees.

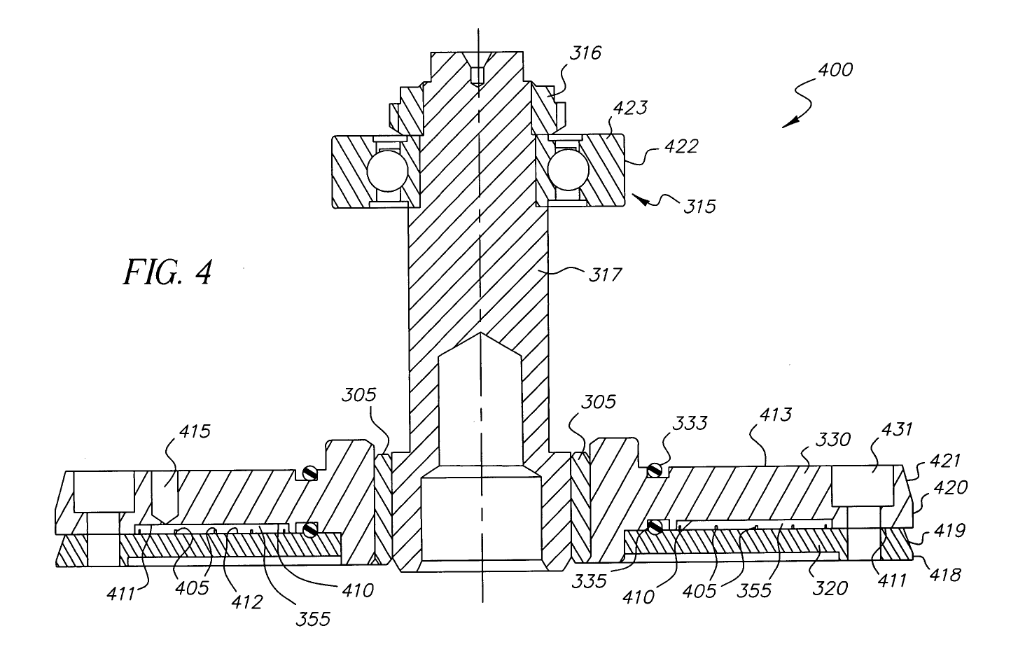

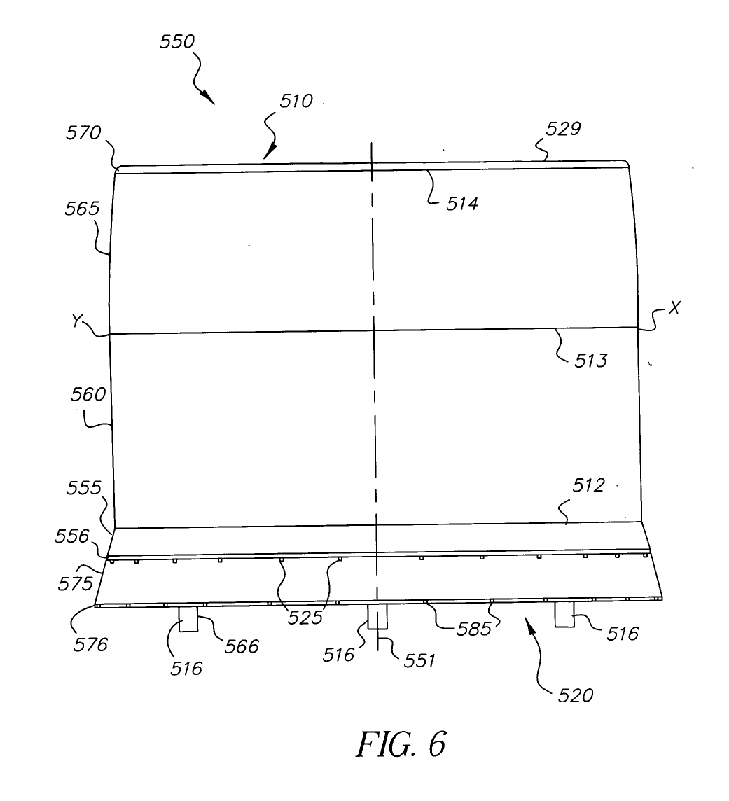

FIG. 3 illustrates a cutaway 3-dimensional view of a portion 300 of an embodiment of a double-sleeved roller preferred for use with the invention. Roller portion 300 includes portions of a securely mounted inner sleeve member (ISM) 350 and a partially-mounted outer sleeve member (OSM) 360 having an inward edge 361. A section of the OSM 360 is omitted so as to reveal the underlying ISM 350 as well as certain elements of the mandrel assembly. A sleeve-supporting member 310 is gripped by ISM 350. Inner termination plate (ITP) 320 is detachably attached to member 310, preferably via bolts or screws (not visible in FIG. 3). Middle termination plate (MTP) 330 is detachably attached to ITP 320, preferably via bolts 331. Outer termination plate (OTP) 340 is detachably attached to MTP 330, preferably via bolts 341, which bolts preferably have threaded ends screwed into MTP 330. The MTP 330 is formed having an annular recess such that with MTP 330 attached to ITP 320 as shown, the ITP 320 and the MTP 330 cooperate so as to form an annular chamber 355 (see also FIG. 4). In addition, the ITP 320 and the MTP 330 cooperate so as to form a plurality of radially-extending channels (not visible in FIG. 6) connecting chamber 355 and the perimeter of MTP 330 (the endings of these channels, corresponding to endings 111 in FIG. 1, are covered by ISM 350).

OTP 340 is formed having an annular recess such that with OTP 340 attached to MTP 330 as shown, the OTP 340 and the MTP 330 cooperate so as to form a second annular chamber 345. In addition, the OTP 340 and the MTP 330 cooperate so as to form a plurality of radially-extending channels connecting chamber 345 and the perimeter of OTP 340, the passageways terminating at channel endings such as endings 343 (corresponding to endings 106 in FIG. 1).

A pipe 311 is provided for transporting pressurized air into chamber 345 for purpose of removing or replacing the partially-mounted outer sleeve member 360 (indicated by the double ended arrow, x . . . x′). Pipe 311 is connectable to a source for the pressurized air, with pipe 311 housed in a hollow portion of member 310. Pipe 311 is connected to an assembly for supplying the pressurized air to chamber 345 via a nozzle 356. A bore 337 connects chambers 345 and 355. A replaceable preferably deformable plug member 336, made for example of rubber, is preferably seated as illustrated on the inward face of the outer termination plate 340 and urged by the OTP 340 against the outward end of bore 337 so as to seal bore 337 and thus prevent pressurized air from passing from chamber 345 into chamber 355. The plug member 336 preferably has a flat surface in contact with OTP 340 and a rounded surface, such as a spherical section, pressed against the outlet of bore 337 as indicated. Annular grooves 332 and 334, for respectively housing O-ring seals 333 and 335, are formed in the outer and inner faces of the middle termination plate 330.

Roller portion 300 is provided with a shaft member 317 which is rotatable inside a bearing 315 having a housing with a cylindrical surface 318, the bearing being secured on shaft member 317 by a nut 316. For demounting or mounting of the outer sleeve member 360 (in directions x, x′) the illustrated end of roller portion 300 is disconnected (see FIG. 1) from a disconnectable supporting member for operationally supporting shaft member 317 (disconnectable supporting member not illustrated). The other end of the roller (not illustrated) is connected to a frame member of the electrostatographic machine so that the roller is supported in cantilever fashion.

Outer termination plate (OTP) 340 is provided with an axially centered round hole defined by circular wall 319, which round hole has a diameter larger than the outer diameter of the cylindrical surface 318. Thus with outer sleeve member 360 completely demounted (slid off the roller in the direction, x) and the bolts 341 removed, the (OTP) 340 is readily removable by translating it in the direction, x, and thereby passing it over the housing of the roller bearing 315. Removal of (OTP) 340 for purpose of replacing the inner sleeve member 350 also permits removal of the plug 336. A guide pin 342 is used to accurately guide positioning of (OTP) 340 and to assist in reinstallation of the bolts 341.

A ring-shaped insulator member 305 made from a ceramic material (and a similar ring-shaped insulator member at the other end of the roller, not shown) provide electrical insulation of the mandrel from the shaft member 319. Thus the mandrel is electrically biasable to any suitable voltage by a power supply, such as indicated in FIG. 1. Ring-shaped insulator member 305 directly contacts and tightly grips a shoulder of shaft 317 which it surrounds (see FIG. 4). The middle termination plate 330 is provided with a central hole 338 in which the ring-shaped insulator member 305 is tightly gripped. Thus a permanently connected structure is formed which embodies the MTP 330, the insulator member 305, and shaft 317.

FIG. 4 shows in cross-section a side view showing a portion 400 of a preferred fixture-accepting configuration (FAC) derived from a partial disassembly of the roller portion 300 of FIG. 3. Certain of the elements of FAC portion 400 are identified by the same numerals as in FIG. 3. FAC portion 400 includes end plate (EP) 330 (identical to the middle termination plate 330 of roller portion 300), inner termination plate (ITP) 320, ceramic insulator member 305, shaft member 317, bearing 315 including a housing 423 having a cylindrical surface 422, and nut 316. ITP 320 includes a portion 418 with a cylindrical outer shape, and a conically tapered portion 419. A complete fixture-accepting configuration which includes FAC portion 400 further includes an inner sleeve member (not shown), a sleeve-supporting member to which ITP 320 attaches (not shown, see for example member 120 of FIG. 1), and various elements such as support elements, bearings, and so forth located at the other end (cantilevering end) of the roller mandrel (as indicated in FIG. 1). The sleeve-replacement fixture of the invention, described in detail below, attaches to a flat outer surface 413 of EP 330 via threaded bolts 441 (corresponding to bolts 341 of FIG. 3). Bolts 441 screw into three threaded receptacles, e.g., receptacle 415 of EP 330. An annular depression 410 and a plurality of radially-directed grooves radiating from depression 410 are located in flat inward surface 411 of EP 330, the grooves terminating at the perimeter of cylindrical portion 420 of EP 330. This cylindrical portion 420 is adjacent a conically tapered portion 421. Via cooperation of members 320 and 330, the annular depression 410 and the plurality of radially-directed grooves form, with flat surface 412 of ITP 320, the annular chamber 355 connected to a plurality of radially-extending channels 405. The starting points of channels 405 from chamber 355 are visible in FIG. 4 (the peripheral endings of channels 405 correspond to endings 111 in FIG. 1).

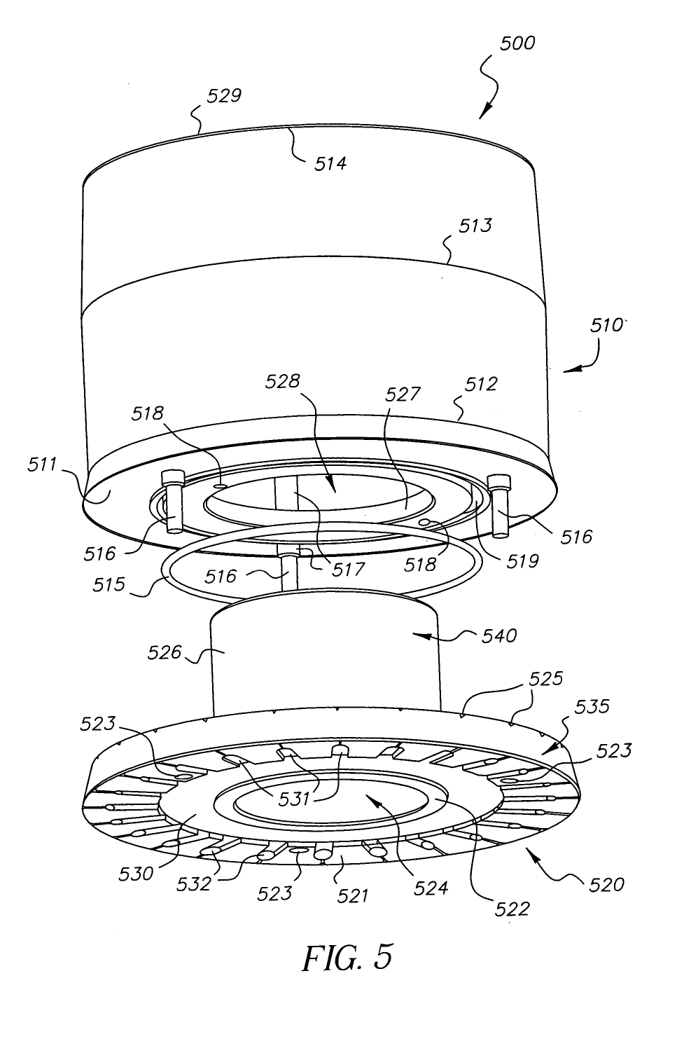

FIG. 5 shows an exploded view (seen from below) of a preferred embodiment 500 of a sleeve-replacement fixture of the invention, the sleeve-replacement fixture (SRF) for attachment to the portion 400 of preferred fixture-accepting configuration (FAC) of FIG. 4. The SRF includes a tubular member (TM) 510, a mating member (MM) 520 for mating to member 330 of FIG. 4, and an O-ring 515 located between the TM 510 and MM 520. The MM 520 includes a generally circular plate-like portion 535 having a central hole 524, the circular plate-like portion having an inward face and an outward face, the inward face not visible in FIG. 5, the outward face defined by outermost coplanar surfaces 521 and 522. An annular depression 530 in the outward face is defined by surfaces 521 and 522. A plurality of relatively wide radially-directed grooves leading from annular depression 530, e.g., grooves 531, are formed in surface 521, which relatively wide radially-directed grooves connect in one-to-one fashion to a plurality of relatively narrow radial grooves formed in surface 521, e.g., grooves 532 terminating at the perimeter of the outward face of circular plate-like portion 535. The plurality of radial grooves includes at least 8 grooves, and in the preferred SRF 500 there are 24 such grooves.

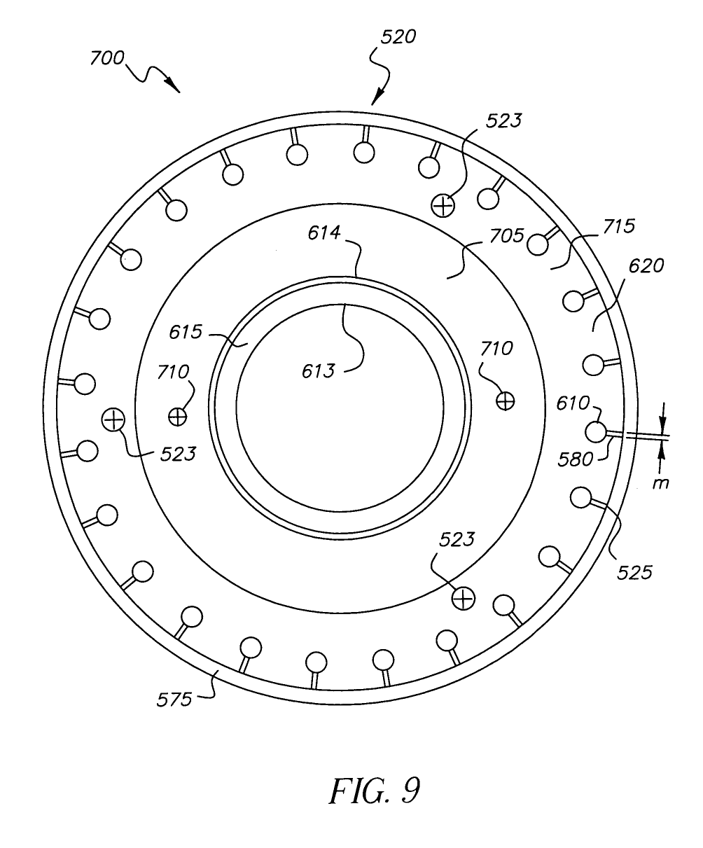

Another plurality of radial grooves (not visible in FIG. 5, see FIG. 9), formed on the inward face of circular plate-like portion 535, have a corresponding plurality of terminations or groove ends 525. The grooves having groove ends 525 are preferably equal in number to the plurality of grooves 532.

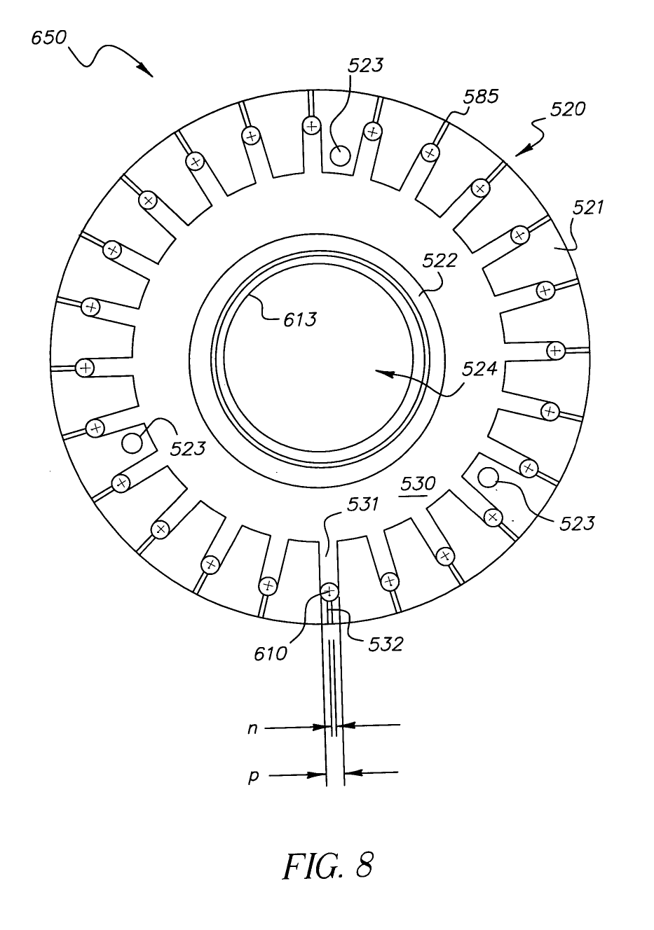

A plurality of bores (not shown in FIG. 5) pass through the circular plate-like portion 535. These bores, located in the relatively wide grooves such as grooves 531, connect the above-mentioned two sets of grooves in one-to-one fashion (see FIGS. 8 and 9).

The MM 520 further includes a central hole 524, which central hole projects into a tubular extension 540 extending axially in a direction away from the inward surface, the tubular extension extending from the central hole.

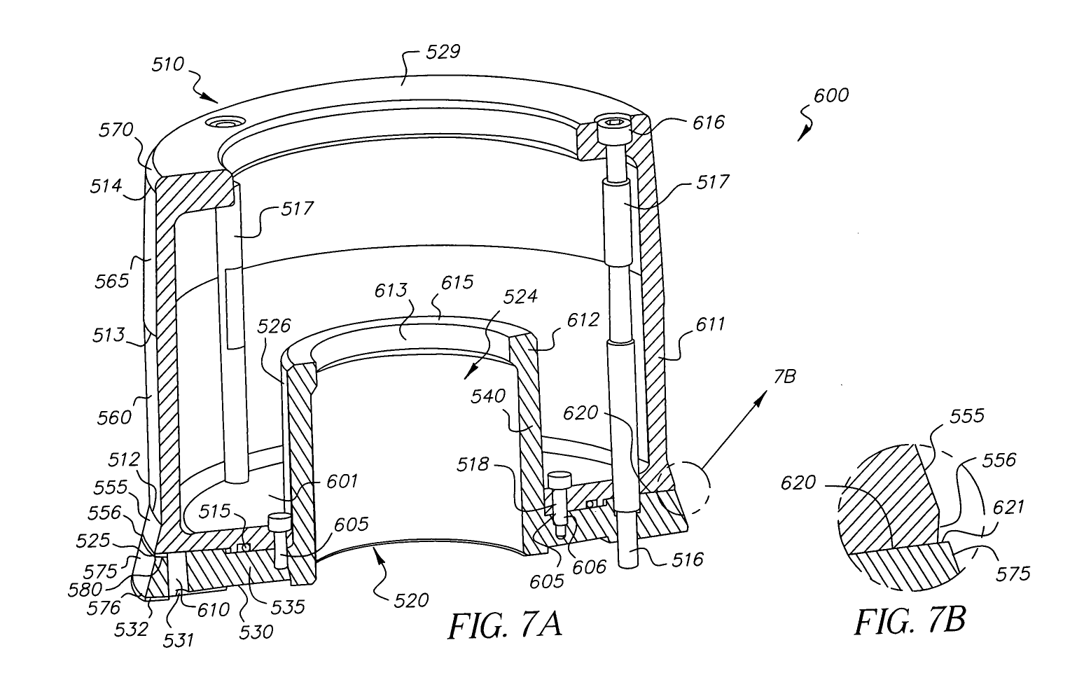

Sleeve-replacement fixture 500 is assembled via two bolts (not illustrated in FIG. 5) passing through preferably unthreaded holes 518 and screwing into corresponding receptacles located in MM 520 (see FIG. 7), with a cylindrical surface 526 of tubular extension 540 passing through a hole 528 in TM 510 so as to fit cylindrical surface 527 with a suitable clearance, the O-ring 515 being squeezed within annular channel 519.

The grooves having groove ends 525 form, in cooperation with flat surface 511, a first set of radially-directed air passageways including at least 8 radially-directed air passageways. With the sleeve-replacement fixture installed on the preferred FAC of FIG. 4, annular depression 530 forms an annular chamber in cooperation with flat face 413, and the grooves 532 form with face 413 a second set of radially-directed air passageways connecting to this annular chamber. The two sets of radially-directed air passageways are connected in one-to-one fashion by the above mentioned bores. (The annular chamber formed by depression 530 and face 413 is analogous to chamber 345 of FIG. 3, with SRF 500 installed in lieu of outer termination plate 340).

For installation of SRF 500 on FAC portion 400, threaded bolt ends 516, which project through TM 510, pass through holes 523 and are screwed into receptacles 415 of FIG. 4, with the flat surface 521 of MM 520 in direct pressure contact with outer surface 415 of member 330, with the surface 522 squeezing O-ring 333 of FAC portion 400 of FIG. 4. The bolt ends 516 are extensions of rods such as rod 517 passing through surface 511 of member 510 (see also FIG. 7A).

The circular plate-like portion 535 has a specified outer shape, preferably a tapered shape tapering (towards member 510 as illustrated) from a maximum diameter equal to the diameter of the outer perimeter of surface 521 (see also FIG. 6).

The tubular member (TM) 510 is generally cylindrically symmetrical about a central axis (for example axis 551, FIG. 6). TM 510 has a specified outer shape about the central axis, with a variable outer diameter perpendicular to the central axis, which variable outer diameter can decrease but not increase moving in a direction away a from flat end face such as surface 511. The preferred TM 510 has a tapered portion between the perimeter of surface 511 and perimeter 512, the tapered portion adjoining a cylindrical length having a constant outer diameter between perimeters 512 and 513, the cylindrical length adjoining a gradually narrowing portion between perimeters 513 and 514.

FIG. 6 shows a side view of the assembled sleeve-replacement fixture of FIG. 5. The preferred specified outer shape of the mating member 520 includes an axially thin cylindrical portion 576 adjacent a conically tapered portion 575. The axially thin cylindrical portion 576 terminates at the surface 521. Groove ends 585 terminate the grooves 532 (FIG. 5) and emerge at the peripheral surface of axially thin cylindrical portion 576 as shown. Groove ends 525 are also shown. The conically tapered portion has a maximum outer diameter equal to the diameter of the perimeter of the portion 576, and has a minimum outer diameter equal to the diameter of the perimeter of the inward face of the mating member inclusive of groove ends 525. The conically tapered portion 575 is defined by a taper angle preferably in a range of approximately between 5°-30°. A taper angle is defined as measured away from a line parallel with the central axis 551 of the sleeve-replacement fixture.

The specified outer shape of the preferred tubular member 510 includes an axially thin cylindrical portion 556 terminating at the flat end surface 511, with portion 556 adjoining a conically tapered portion 555 having a maximum outer diameter and a minimum outer diameter, with the maximum diameter equal to the outer diameter of the axially thin cylindrical portion. The conically tapered portion 555 defined by a taper angle preferably in a range of approximately between 5°-30°.

The taper angle of the conically tapered portion 421 of end plate (middle termination plate) 330 of FIG. 4 is equal to a specified number of degrees. Additionally, the taper angle of the conically tapered portion 575 of mating member 520 is equal to a specified number of degrees, and the taper angle of the conically tapered portion 555 of the tubular member 510 is equal to a specified number of degrees. It is preferred that the taper angles of tapered portions 421, 555, and 575 are equal to one another.

The conically tapered portion 555 adjoins a cylindrical length 560, the cylindrical length having an outer diameter which is substantially constant and equal to the minimum outer diameter of the conically tapered portion.

The cylindrical length 560 further adjoins a gradually narrowing portion 565 of the tubular member 510, the gradually narrowing portion having a greatest outer diameter equal to the diameter of the cylindrical length, with the gradually narrowing portion monotonically decreasing in diameter from this greatest outer diameter between perimeters 513 and 514. Preferably, there is an axially thin end section 570 of the tubular member 510 located between the perimeter 514 and a terminal face 529 of TM 510, which end section has a rounded shape to aid the mounting of an inner sleeve member on the fixture 550.

The gradually narrowing portion 565 can have any suitable shape. Preferably, the shape of portion 565 has a profile defined by arcs which are portions of circles having centers at points X and Y. Thus an arc centered at point X is tangent to the surface of cylindrical portion 560 at point Y, with the arc continuing to perimeter 514. In an exemplary embodiment, perimeter 513 can have a diameter of 162.57 mm with an arc radius of 575 mm±5 mm.

Preferably tubular member 510 and mating member 520 are made of an aluminum alloy and are preferably externally coated by an anodized hardcoat. Furthermore, at least a portion of SRF 550 includes an outer coating of any suitable low surface energy (LSE) material. Preferably, the low surface energy material is a fluoropolymer having a thickness in a range of approximately between 0.025-0.10 mm. The fluoropolymer is preferably coated on to anodized hardcoated tubular member 510. More preferably, the coating material is a PTFE (polytetrafluorethylene) material obtainable from General Magnaplate Corp. of Linden, N.J., under the tradename “Lectrofluor 615”. This PTFE material is coated via a vacuum deposition process to a preferred thickness of about 0.05 mm.

FIG. 7A shows a cut-away section and three-dimensional view, indicated by the numeral 600, of the sleeve-replacement fixture 550. Certain elements identified numerically in FIGS. 4, 5, and 6 are similarly identified in FIG. 7A. The MM 520 is shown cross-hatched for clarity. MM 520 is attached to tubular member 510 by the two bolts 605 which pass through holes 518 and screw into threaded surfaces such as surface 606. Bolt ends 516 are connected to rods 517 which terminate in screw heads 616 that are permanently bonded to rods 517. An annular end portion 601 of tubular member 510 contains O-ring 515, with portion 601 fitting into an annular depression located in the inward face of MM 520 (see FIG. 9). The central hole 524 of the tubular extension 540 includes a portion 612 with a surface 613 having an inner diameter of a suitable size to surround, with a suitable clearance, surface 422 of the cylindrical housing 423 enclosing bearing 315 mounted on shaft member 317 (see FIG. 4). Tubular extension 540 ends in surface 615.

An enlargement, FIG. 7B, shows details of the view 600 where tubular member 510 peripherally meets mating member 520. The axially thin cylindrical portion 556 of TM 510, adjacent conically tapered portion 555, terminates the TM 510 at a flat surface forming an interface with inward surface 620 of MM 520 (see FIG. 9 for details of inward surface of MM 520). Preferably, the outer diameter of cylindrical portion 556 is smaller than the diameter of the perimeter of surface 620, thereby producing a narrow ledge 621 at the inward end of conically tapered portion 575 of MM 520.

The annular depression 530 connects to the relatively wide radially-directed groove 531 which enters a bore 610 passing through circular plate-like portion 535. Also entering bore 610 is a relatively narrow radial groove 580 terminating at the groove end 525. Groove 580, in cooperation with surface 511 of tubular member 510 (FIG. 5), forms one of a first set of radially-directed air passageways for connection to the source of pressurized air, as described previously above. Groove 532 (see FIG. 5) also connects to bore 610. After installation of fixture 600, groove 532, in cooperation with surface 413 of end plate 330 (FIG. 4), forms one of a second set of radially-directed air passageways for connection to the source of pressurized air. Note that groove ends 525 terminate in the conically tapered surface 575, and that groove ends 585 terminate in the surface of axially thin cylindrical portion 576.

FIG. 8 illustrates the outward face 650 of the mating member included in the preferred embodiment of the sleeve-replacement fixture of the invention (also see FIG. 5). The outward face includes surfaces 521 and 522 in which are formed the annular depression 530, the plurality of relatively wide grooves such as groove 531, and the corresponding plurality of relatively narrow grooves such as groove 532. Preferably, these pluralities are at least 8 in number, and more preferably, 24 in number, as illustrated. The relatively wide grooves are preferably equally spaced circumferentially, and preferably have a width, p, of about 6 mm. The relatively narrow grooves preferably have a width, n, of about 1 mm. However, any suitable widths p and n can be used. The annular depression, the relatively wide grooves, and the relatively narrow grooves can have any suitable depths. These depths are preferably equal to one another, preferably about 1 mm.

FIG. 9 illustrates the inward face 700 of the mating member included in the preferred embodiment of the sleeve-replacement fixture of the invention. Inward face 700 includes a flat surface 715 in which is formed an annular depression 705 into which portion 601 of the tubular member 510 fits. Receptacles 710, having threaded walls 606, are for receiving threaded bolts 605. Bores such as bore 610 pass through the surface 705 to connect to the relatively wide grooves such as groove 531. Included in face 700 are a plurality of radial grooves, such as groove 580, which grooves are preferably equally spaced circumferentially, and which grooves connect to the bores, e.g., bore 610. Preferably, the plurality of grooves inclusive of groove 580 is at least 8 in number, and more preferably, 24 in number, as illustrated. These grooves have a width, m, which is preferably about 1 mm. The grooves such as groove 580 are preferably about 1 mm in depth. However, any suitable depth and corresponding width m can be used.

It is preferred, as illustrated in FIGS. 8 and 9, that the bores such as bore 610 connect in one-to-one fashion the preferably equal pluralities of grooves 580 and 532.

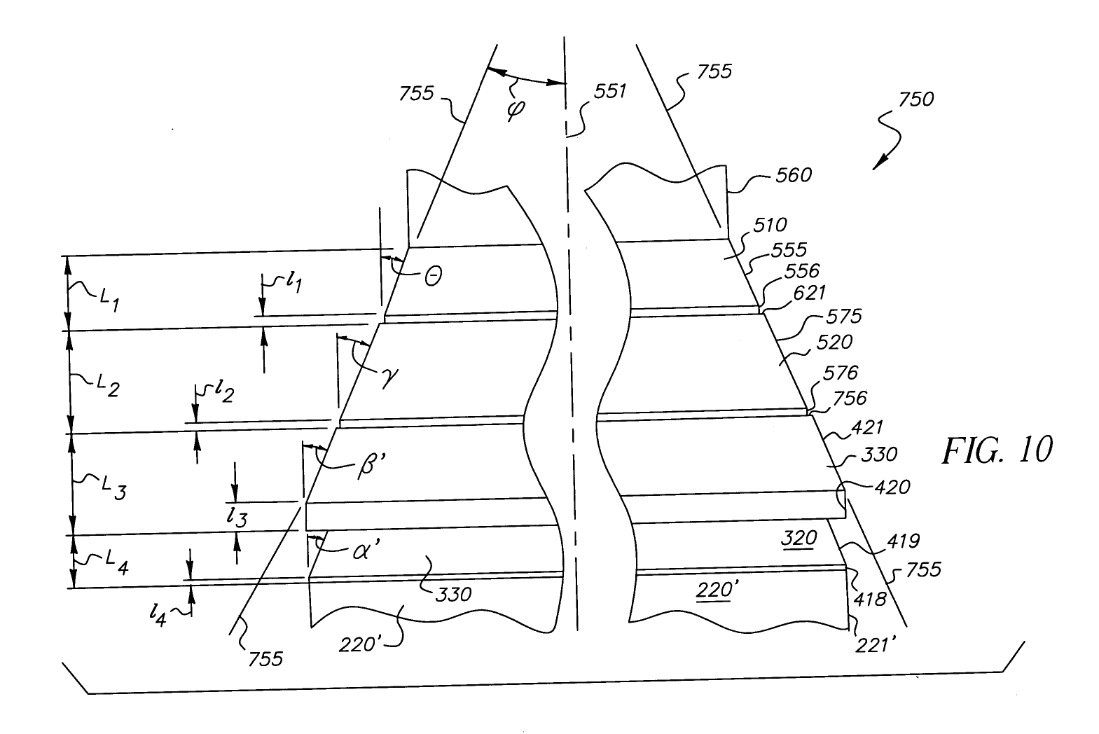

FIG. 10 shows, in a side outside view, a structure 750 which includes a portion of the preferred embodiment of the sleeve-replacement fixture of the invention installed on the preferred fixture-accepting configuration portion illustrated in FIG. 4. Certain elements identified numerically in FIGS. 3, 4, 6, and 7A are similarly identified in FIG. 10. Certain other elements identified by a prime (′) correspond to similar elements in FIGS. 2A and 2B. Thus tubular member 510 is attached to mating member (MM) 520, the MM is attached to end plate (EP) 330, the end plate is attached to inner termination plate 320, and the inner termination plate is attached to sleeve-supporting member 220′. A ledge 756, similar to the previously described ledge 621 formed at the junction of the members 510 and 520, is formed at the junction of MM 520 and EP 330.

Taper angles α′, β′, γ, and θ respectively define the conically tapered portions 419, 421, 575, and 555. As indicated in FIG. 10, these taper angles are defined as measured from lines parallel to the central axis 551. It is preferred that angle β′ be equal to a specified number of degrees, and that angles γ and θ are each equal to this specified number of degrees. With the angle α′ of the conically tapered portion 419 preferably having a value of about 15°±5°, the angle β′ of conically tapered portion 421 of end plate (EP) 330 preferably has a specified number of degrees of about 15°±0.5°. Hence, for the conically tapered portions 555, 575 of the respective members 510, 520 of the sleeve-replacement fixture included in structure 750, the preferred specified number of degrees of each of the taper angles γ and θ is about 15°±0.5°.

More generally, it is preferred that each of the specified number of degrees of angles β′, γ, and θ is equal to an indicated angle in common, φ. As shown in FIG. 10, angle φ is measured from axis 551. It is further preferred that the conically tapered portions of the middle termination plate, of the mating member, and of the tubular member are mutually defined by a conical envelope indicated by the lines 755. Thus it is preferred that the lines 755 are coincident with the respective outer surfaces of the conically tapered portions 555, 575, and 421.

In structure 750, it is preferred that the length L₁, which is equal to the combined axial thicknesses of tapered portion 555 and cylindrical portion 556, be about 6 mm±1 mm. Preferably, the thickness of cylindrical portion 556, l₁, is in a range of approximately between 0.5 mm-2.0 mm, and more preferably is about 0.93 mm. Preferably, the length L₂, which is equal to the combined axial thicknesses of tapered portion 575 and cylindrical portion 756, is about 14.0 mm, and preferably the thickness of cylindrical portion 756, l₂, is in a range of approximately between 0.5 mm-2.0 mm, and more preferably is about 0.93 mm. Preferably, the length L₃, which is equal to the combined axial thicknesses of tapered portion 421 and cylindrical portion 420, is about 14.0 mm, and preferably the thickness of cylindrical portion 420, l₃, is about 3.8 mm. The length L₄, which is equal to the combined axial thicknesses of tapered portion 419 and cylindrical portion 418, is not critical, and is typically about 7 mm. Preferably, the thickness of cylindrical portion 418, l₄, is about 1.0 mm or less.

Notwithstanding the above-disclosed preferred values of taper angles and axial thicknesses in structure 750, it is to be understood that any suitable individual values of taper angles and axial thicknesses may be used.

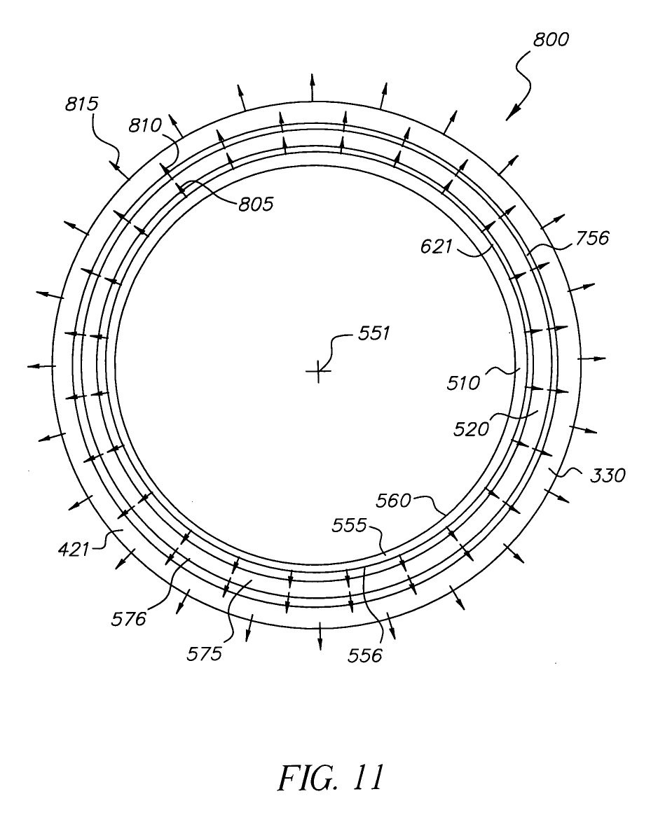

FIG. 11 is an axially directed view 800, along central axis 551, of the structure of FIG. 10, showing a staggering between air jets that can be formed by the two preferably aligned sets of radially-directed air passageways formed by the sleeve-replacement fixture of the invention illustrated in FIG. 6 and the air jets that can be formed by a plurality of radial channels included in the fixture-accepting configuration portion illustrated in FIG. 4. The two preferably aligned sets of radially-directed air passageways formed by the sleeve-replacement fixture include the groove ends 525 and 585 in FIG. 6.

In the preferred embodiment 800 of FIG. 11, the plurality of radial channels included in the fixture-accepting configuration portion illustrated in FIG. 4 can produce a corresponding plurality of radially-directed air jets 815 when the radial channels are connected to the source of pressurized air. Also, the two preferably aligned sets of radially-directed air passageways formed by the sleeve-replacement fixture can produce corresponding pluralities of radially-directed air jets 805 and 810 when the radially-directed air passageways, inclusive of groove ends 525 and 585 respectively, are connected to the source of pressurized air.

As illustrated in FIG. 11, the numbers of jets 815 is equal to the number of jets 805 and to the number of jets 810, i.e., the pluralities of radially-directed grooves giving rise to the radially-directed air passageways for producing jets 805, 810 is equal in number to the plurality of radial channels (located between the inner termination plate 320 and the middle termination plate 330) for producing jets 815.

The terminations of the pluralities of radially-directed grooves 525, 585 giving rise to the radially-directed air passageways for producing jets 805, 810 are not rotationally staggered, relative to one another, around central axis 551. Each set of terminations is separated pairwise by a specified angle subtended at central axis 551, which specified angle is preferably 15° as illustrated. However, the channel endings of the plurality of radial channels located peripherally between members 330 and 320 are preferably rotationally staggered, relative to the terminations of the pluralities of radially-directed grooves 525 and 585, by a rotational angle equal to one-half of the specified angle subtended at central axis 551, i.e., by 7.5° in FIG. 11. Notwithstanding the above specifications for the preferred embodiment 800, it is to be understood that any suitable number of air jets can be included in the pluralities of air jets inclusive of air jets such as jets 805, 810, 815. It will also be understood that any suitable rotational staggering of these pluralities of air jets relative to one another can be used in the practice of the invention. A key requirement of the invention, with the sleeve-replacement fixture installed on the fixture-accepting configuration as shown in FIG. 11 and with the source of pressurized air connected, is that three sets of radially-directed air jets are formed so that an inner sleeve member is slidably movable over the sleeve-replacement fixture to an operational position on a bare sleeve-supporting member, e.g., member 220′ (FIG. 10). Similarly, when removing an inner sleeve member, e.g., for replacement, the three sets of radially-directed air jets can also be formed so that the inner sleeve member is slidably movable off the sleeve-supporting member and thence over the sleeve-replacement fixture.

A method is disclosed for replacing an inner sleeve member (ISM) included in a fixture-accepting configuration (FAC), the FAC derived from a double-sleeved roller by partial disassembly thereof, the method utilizing a sleeve-replacement fixture (SRF) for reversible attachment to the FAC, the FAC including (i) a sleeve-supporting member (SSM) supported in cantilever fashion at one end of two ends of the SSM, (ii) an inner termination plate (ITP) attached to the sleeve-supporting member at the other end of the SSM, (iii) an end plate (EP) attached to the ITP, and (iv) the ISM, the ITP having a cylindrical portion and an adjoining conically tapered portion, the ISM grippingly surrounding the SSM as well as the cylindrical portion of the ITP, the ISM extending over the adjoining conically tapered portion of the ITP with the ISM further grippingly surrounding the cylindrical portion of the EP as well as a part of an adjoining conically tapered portion of the EP, the EP cooperatively forming with the ITP a plurality of radial channels connectable to a source of pressurized air deliverable from the source to the ISM for radial expansion thereof, the SRF including a tubular member having a low-surface-energy coating and a mating member (MM) attached thereto, the tubular member and the MM cooperatively forming a first set of radially-directed air passageways for connection to the source of pressurized air, the MM having two faces connected by a plurality of bores leading into the first set of radially-directed air passageways, each of the tubular member and the MM having an axially thin cylindrical portion adjacent a conically tapered portion with the conically tapered portion tapering away from the axially thin cylindrical portion, wherein in a condition with the SRF attached to the FAC the conically tapered portions of the TM and the MM and the EP are mutually defined by a conical envelope, wherein in the condition with the SRF attached to the FAC the axially thin cylindrical portions of the MM and the tubular member are closer to the other end of the SSM than are the conically tapered portions, such that the conically tapered portions taper in a direction away from the other end of the SSM, the tubular member further including a cylindrical length smoothly adjoining the conically tapered portion where the tapered portion of the tubular member has a minimum outer diameter, the cylindrical length adjoining a gradually narrowing portion of the tubular member, the gradually narrowing portion having a greatest outer diameter equal to the diameter of the cylindrical length, the method for replacing the ISM on the FAC including the steps of (a) connecting the MM of the SRF to the EP such that the MM and the EP cooperatively create a second set of radially-directed air passageways connectable to the source of pressurized air, the bores joining in one-to-one fashion the second set of radially-directed air passageways to the first set of radially-directed air passageways (b) opening the source of pressurized air, thereby supplying pressurized air to the plurality of radial channels, to the first set of radially-directed air passageways, and via the bores to the second set of radially-directed air passageways (c) slidably moving the ISM off the FAC (d) with the source of pressurized air open, slidably moving a replacement ISM to an operational location on the FAC (e) closing the source of pressurized air, and (f) disconnecting the SRF from the EP.

A method is disclosed for replacing an inner sleeve member (ISM) grippingly mounted on a mandrel included in a double-sleeved roller (DSR), the DSR having two ends, the two ends including a disconnectable end operationally supported by a removable support member, the DSR including an outer sleeve member (OSM) surrounding the ISM, the mandrel inclusive of a rigid sleeve-supporting member having joined thereto at the disconnectable end three termination plates having specified outer shapes, each of which outer shapes including a cylindrical portion adjacent a conically tapered portion, the termination plates including an inner termination plate (ITP), a middle termination plate (MTP), and an outer termination plate (OTP), wherein the ISM extends so as to cover the cylindrical portion of the ITP and a part of the adjacent conically tapered portion of the MTP, the OSM extending over the ITP and beyond the MTP so as to substantially cover only the cylindrical portion of the OTP, the MTP cooperatively forming with the ITP a first plurality of radial channels connectable to a source of pressurized air selectably deliverable from the source to said ISM for radial expansion thereof, the first plurality of radial channels being blocked from the source by a reversible blockage, the OTP cooperatively forming with the MTP a second plurality of radial channels, the second plurality of radial channels not blocked by a blockage and thus directly connectable to the source, the pressurized air deliverable from the source to the OSM for radial expansion thereof, the method utilizing a disconnectably attachable sleeve-replacement fixture comprising a tubular member and a mating member (MM) joined thereto, the tubular member and the MM cooperatively forming a first set of radially-directed air passageways for connection to the source of pressurized air, the MM having two faces connected by a plurality of bores leading into the first set of radially-directed air passageways, each of the tubular member and the MM having an axially thin cylindrical portion adjacent a conically tapered portion, with the conically tapered portion tapering away from the axially thin cylindrical portion, wherein in a condition with the SRF attached to the FAC, the axially thin cylindrical portions of the MM and the tubular member are closer to the other end of the SSM than are the conically tapered portions, such that the conically tapered portions taper in a direction away from the other end of the SSM, the tubular member further including a cylindrical length smoothly adjoining the conically tapered portion where the tapered portion of the tubular member has a minimum outer diameter, the cylindrical length adjoining a gradually narrowing portion of the tubular member, the gradually narrowing portion having a greatest outer diameter equal to the diameter of the cylindrical length, the method for replacing the ISM on the DSR including the steps of (a) moving the removable support member away from the disconnectable end with the mandrel supported in cantilever fashion at the other end of the two ends (b) opening the source of pressurized air to the second plurality of radial channels (c) slidably moving the OSM off the mandrel (d) closing the source of pressurized air (e) removing the outer termination plate from the MTP (f) unblocking the reversible blockage (g) connecting the MM of the sleeve-replacement fixture to the MTP such that the MM and the MTP cooperatively create a second set of radially-directed air passageways connectable to the source of pressurized air, the bores joining in one-to-one fashion the second set of radially-directed air passageways to the first set of radially-directed air passageways (h) opening the source of pressurized air, thereby supplying pressurized air to the first plurality of radial channels, to the first set of radially-directed air passageways, and via the bores to the second set of radially-directed air passageways (i) slidably moving the ISM off the mandrel (j) with the source of pressurized air open, slidably moving a replacement ISM to an operational location on the mandrel (k) closing the source of pressurized air (l) disconnecting the sleeve-replacement fixture from the MTP (m) blocking, with a reversible blockage, the source of pressurized air from reaching the first plurality of radial channels (n) replacing the outer termination plate thereby reforming the first plurality of radial channels (O) reopening the source of pressurized air (p) slidably moving an OSM over the replacement ISM to an operational location on the mandrel; and (q) closing the source of pressurized air.

The invention has been described in detail with particular reference to certain preferred embodiments thereof, but it will be understood that variations and modifications can be effected within the spirit and scope of the invention.

1. A sleeve-replacement fixture (SRF), said SRF for aiding replacement of an inner sleeve member (ISM) of a double-sleeved roller (DSR), said DSR inclusive of a mandrel with said ISM gripping said mandrel and an outer sleeve member (OSM) surrounding said ISM, said DSR having two ends including a disconnectable end supported by a removable support member, said disconnectable end including a shaft member with a bearing mounted on said shaft member, said bearing enclosed by a cylindrical housing, said mandrel inclusive of a sleeve-supporting member, said sleeve-supporting member rotatably supported at the other end of said two ends, said sleeve-supporting member connected to an inner termination plate (ITP) at said disconnectable end, said ITP connected to a middle termination plate (MTP), said MTP having an outer surface connected to an outer termination plate (OTP), said MTP cooperating with said ITP to form a plurality of radial channels therebetween connectable to a source of pressurized air, said radial channels terminating peripherally at corresponding channel endings located peripherally between said MTP and said ITP, said pressurized air deliverable from said source to said channel endings and thus to said ISM for radial expansion thereof, said plurality of radial channels blocked from said source by a reversible blockage, said OTP of said DSR operationally connected to said removable support member, said sleeve-replacement fixture comprising: a fixture-accepting configuration (FAC) derived from said DSR for receiving said SRF, said FAC obtained by partially disassembling said DSR via the steps of (a) removing said removable support member from said disconnectable end, (b) removing said OSM, (c) removing said OTP, and (d) unblocking said blockage, wherein said FAC includes (i) said sleeve-supporting member supported in cantilever fashion at said other end of said two ends, (ii) said ITP, (iii) said MTP, and (iv) said ISM, said ITP having a cylindrical portion and an adjoining conically tapered portion having a taper angle in a range of approximately between 5°-45°, wherein said sleeve-supporting member is gripped by said ISM and said ISM extends past said cylindrical portion and over and beyond said adjoining conically tapered portion of said ITP such that said ISM covers a cylindrical portion of said MTP as well as a part of an adjoining conically tapered portion of said MTP, said conically tapered portion of said MTP having a taper angle in a range of approximately between 5°-45°, and wherein said sleeve-replacement fixture has an outer surface having a specified shape, said specified shape cylindrically symmetrical, said sleeve-replacement fixture being disconnectably attachable to said MTP of said FAC;
a tubular member having two ends, said tubular member generally cylindrically symmetrical about a central axis, with one end of said tubular member terminating in a flat end surface for joining said tubular member to a mating member, said tubular member having a specified outer shape about said central axis;
said mating member (MM) comprising a generally circular plate-like portion having a central hole, said circular plate-like portion having an inward face and an outward face, said inward face attached to said flat end surface of said tubular member, said outward face for attachment to said outer surface of said MTP of said fixture-accepting configuration, said circular plate-like portion having a specified outer shape about said central axis;
wherein said flat end surface of said tubular member and said inward face of said circular plate-like portion of said MM cooperatively form a first set of radially-directed air passageways for connection to said source of pressurized air, said inward face and said outward face of said circular plate-like portion connected by a plurality of bores, said bores passing through said circular plate-like portion, said bores connecting in one-to-one fashion with said first set of radially-directed air passageways;
wherein, with said sleeve-replacement fixture installed such that said mating member (MM) is attached to said middle termination plate (MTP), said MM and said MTP cooperatively create a second set of radially-directed air passageways connectable to said source of pressurized air, said bores joining in one-to-one fashion said second set of radially-directed air passageways to said first set of radially-directed air passageways, said first and second sets having equal numbers of radially-directed air passageways; and
wherein, with said source of pressurized air connected to said first and second sets of radially-directed air passageways as well as to said plurality of radial channels so as to form three sets of radially-directed air jets, said inner sleeve member is slidably movable over said sleeve-replacement fixture and off said mandrel so as to produce a bare sleeve-supporting member.

2. The sleeve-replacement fixture according to claim 1, wherein said specified outer shape of said mating member includes an axially thin cylindrical portion adjacent a conically tapered portion, said conically tapered portion having a maximum outer diameter and a minimum outer diameter, said axially thin cylindrical portion having said maximum outer diameter, said axially thin cylindrical portion terminating at said outward face, said conically tapered portion defined by a taper angle in a range of approximately between 5°-30°.

3. The sleeve-replacement fixture according to claim 1, wherein said specified outer shape of said tubular member has a variable outer diameter perpendicular to said central axis, said variable outer diameter being maximum at said flat end surface, which variable outer diameter can decrease but not increase moving in a direction away from said flat end surface, said flat end surface in contact with said mating member.

4. The sleeve-replacement fixture according to claim 1, wherein said specified outer shape of said tubular member includes an axially thin cylindrical portion terminating at said flat end surface, said axially thin cylindrical portion of said tubular member adjoining a conically tapered portion, said conically tapered portion of said tubular member having a maximum outer diameter and a minimum outer diameter, said axially thin cylindrical portion having said maximum outer diameter, said conically tapered portion defined by a taper angle in a range of approximately between 5°-30°.

5. The sleeve-replacement fixture according to claim 4, wherein:
said taper angle of said conically tapered portion of said middle termination plate is equal to a specified number of degrees;
said taper angle of said conically tapered portion of said mating member is equal to said specified number of degrees;
said taper angle of said conically tapered portion of said tubular member is equal to said specified number of degrees; and
said conically tapered portions of said middle termination plate, of said mating member, and of said tubular member being mutually defined by a conical envelope.

6. The sleeve-replacement fixture according to claim 4, wherein said conically tapered portion of said tubular member adjoins a cylindrical length of said tubular member, said cylindrical length having an outer diameter which is substantially constant, said outer diameter of said cylindrical length being equal to said minimum outer diameter of said conically tapered portion of said tubular member.

7. The sleeve-replacement fixture according to claim 6, wherein said cylindrical length further adjoins a gradually narrowing portion of said tubular member, said gradually narrowing portion having a greatest outer diameter equal to said diameter of said cylindrical length, said gradually narrowing portion monotonically decreasing in diameter from said greatest outer diameter.

8. The sleeve-replacement fixture according to claim 7, wherein at least a portion of said sleeve-replacement fixture includes an outer coating made from a low surface energy material.

9. The sleeve-replacement fixture according to claim 8, wherein said low surface energy material comprises a fluoropolymer coated on said tubular member of said sleeve-replacement fixture, said outer coating having a thickness in a range of approximately between 0.025-0.10 mm.

10. The sleeve-replacement fixture according to claim 1, wherein:
said central hole of said mating member projects into a tubular extension extending axially in a direction away from said inward surface, said tubular extension including said central hole; and
with said sleeve-replacement fixture installed on said fixture-accepting configuration, said central hole of said tubular extension includes a portion with an inner diameter of a suitable size to surround, with a suitable clearance, an outer surface of said cylindrical housing enclosing said bearing mounted on said shaft member.

11. The sleeve-replacement fixture according to claim 1, wherein:
said inward face of said circular plate-like portion of said mating member includes a first plurality of radially-directed grooves for forming with said flat end surface of said tubular member said first set of air passageways, said first plurality of radially-directed grooves being equal in number to said plurality of bores, each bore connecting to a respective groove, said first plurality of radially-directed grooves having terminations at the periphery of said inward face of said circular plate-like portion;
said outward face of said circular plate-like portion includes an annular depression; and
said outward face of said circular plate-like portion further includes a second plurality of radially-directed grooves for forming with said outer surface of said middle termination plate said second set of air passageways, said second plurality of radially-directed grooves being equal in number to said plurality of bores, each bore connecting to a respective groove of said second plurality of radially-directed grooves, said second plurality of radially-directed grooves starting at said annular depression and having terminations at the periphery of said outward face of said circular plate-like portion.

12. The sleeve-replacement fixture according to claim 11, wherein:
said first plurality of radially-directed grooves is equal in number to said plurality of radial channels between said inner termination plate and said middle termination plate;
said terminations of said first plurality of radially-directed grooves are separated pairwise by a specified angle subtended at said central axis, said terminations of said second plurality of radially-directed grooves being separated pairwise by said specified angle subtended at said central axis;
said terminations at the periphery of said inward face and said terminations at the periphery of said outward face are not rotationally staggered, relative to one another, around said central axis; and
said channel endings of said plurality of radial channels located peripherally between said MTP and said ITP are rotationally staggered, relative to said terminations at said peripheries, by a rotational angle equal to one-half of said specified angle subtended at said central axis.

13. The sleeve-replacement fixture according to claim 1, said sleeve-replacement fixture being installed on said fixture-accepting configuration with said mating member of said sleeve-replacement fixture attached to said middle termination plate, wherein, with said source of pressurized air connected to said first and second sets of radially-directed air passageways as well as to said plurality of radial channels so as to form said three sets of radially-directed air jets, an inner sleeve member is slidably movable over said sleeve-replacement fixture to an operational position on said bare sleeve-supporting member.

14. A sleeve-replacement fixture (SRF) for aiding replacement of an inner sleeve member (ISM) of a double-sleeved roller (DSR), said (ISM) mounted on a fixture-accepting configuration (FAC), said FAC derived from said DSR by a partial disassembly thereof, said FAC including (i) a sleeve-supporting member (SSM) supported in cantilever fashion at one end of two ends of said SSM, (ii) an inner termination plate (ITP) attached to said sleeve-supporting member at the other end of said SSM, (iii) an end plate (EP) attached to said ITP, and (iv) said ISM, said sleeve-replacement fixture being disconnectably attachable to said EP, said ITP having a cylindrical portion and an adjoining conically tapered portion, said conically tapered portion having a taper angle in a range of approximately between 5°-45°, said ISM grippingly surrounding said SSM as well as said cylindrical portion of said ITP, said ISM extending over said adjoining conically tapered portion of said ITP with said ISM further grippingly surrounding said cylindrical portion of said EP as well as a part of an adjoining conically tapered portion of said EP, said EP cooperatively forming with said ITP a plurality of radial channels therebetween, said radial channels connectable to a source of pressurized air, said pressurized air deliverable from said source to said ISM for radial expansion thereof, said SRF comprising:
a tubular member and a mating member (MM) attached thereto, said tubular member and said MM cooperatively forming a first set of radially-directed air passageways for connection to said source of pressurized air, said MM having two faces connected by a plurality of bores, said bores making connections to said first set of radially-directed air passageways, each of said tubular member and said MM having an axially thin cylindrical portion adjacent a conically tapered portion with said conically tapered portion tapering away from said axially thin cylindrical portion, which conically tapered portions of said tubular member and said MM have taper angles equal in magnitude to said taper angle of said conically tapered portion of said EP, said tubular member further including a cylindrical length, said cylindrical length smoothly adjoining said conically tapered portion where said tapered portion has a minimum outer diameter, said cylindrical length further adjoining a gradually narrowing portion of said tubular member, said gradually narrowing portion having a greatest outer diameter equal to said diameter of said cylindrical length, said tubular member coated with a low surface energy coating;
wherein, in a condition with said SRF attached to said FAC, said axially thin cylindrical portions of said MM and said tubular member are closer to said other end of said SSM than are said conically tapered portions, such that said conically tapered portions taper in a direction away from said other end of said SSM;
wherein, with said SRF installed such that said MM is attached to said EP, said conically tapered portions of said TM, said MM and said EP are mutually defined by a conical envelope;
wherein, with said SRF installed such that said MM is attached to said EP, said MM and said EP cooperatively create a second set of radially-directed air passageways connectable to said source of pressurized air, said bores joining in one-to-one fashion said second set of radially-directed air passageways to said first set of radially-directed air passageways; and
wherein, for purposes of removing and replacing an inner sleeve member on said FAC, three sets of air jets are formed, said air jets emanating respectively from said first set of radially-directed air passageways, from said second set of radially-directed air passageways, and from said plurality of radial channels between said EP and said ITP.

15. A method for replacing an inner sleeve member (ISM) included in a fixture-accepting configuration (FAC), said FAC derived from a double-sleeved roller by partial disassembly thereof, said method utilizing a sleeve-replacement fixture (SRF), said SRF for reversible attachment to said FAC, said FAC including (i) a sleeve-supporting member (SSM) supported in cantilever fashion at one end of two ends of said SSM, (ii) an inner termination plate (ITP) attached to said sleeve-supporting member at the other end of said SSM, (iii) an end plate (EP) attached to said ITP, and (iv) said ISM, said ITP having a cylindrical portion and an adjoining conically tapered portion, said ISM grippingly surrounding said SSM as well as said cylindrical portion of said ITP, said ISM extending over said adjoining conically tapered portion of said ITP with said ISM further grippingly surrounding said cylindrical portion of said EP as well as a part of an adjoining conically tapered portion of said EP, said EP cooperatively forming with said ITP a plurality of radial channels connectable to a source of pressurized air, said pressurized air deliverable from said source to said ISM for radial expansion thereof, said SRF comprising a tubular member having a low-surface-energy coating and a mating member (MM) attached thereto, said tubular member and said MM cooperatively forming a first set of radially-directed air passageways for connection to said source of pressurized air, said MM having two faces connected by a plurality of bores leading into said first set of radially-directed air passageways, each of said tubular member and said MM having an axially thin cylindrical portion adjacent a conically tapered portion with said conically tapered portion tapering away from said axially thin cylindrical portion, wherein in a condition with said SRF attached to said FAC said conically tapered portions of said TM and said MM and said EP are mutually defined by a conical envelope, wherein in said condition with said SRF attached to said FAC said axially thin cylindrical portions of said MM and said tubular member are closer to said other end of said SSM than are said conically tapered portions, such that said conically tapered portions taper in a direction away from said other end of said SSM, said tubular member further including a cylindrical length, said cylindrical length smoothly adjoining said conically tapered portion where said tapered portion of said tubular member has a minimum outer diameter, said cylindrical length adjoining a gradually narrowing portion of said tubular member, said gradually narrowing portion having a greatest outer diameter equal to said diameter of said cylindrical length, said method for replacing said ISM on said FAC including the steps of:
connecting said MM of said SRF to said EP such that said MM and said EP cooperatively create a second set of radially-directed air passageways connectable to said source of pressurized air, said bores joining in one-to-one fashion said second set of radially-directed air passageways to said first set of radially-directed air passageways;
opening said source of pressurized air, thereby supplying pressurized air to said plurality of radial channels, to said first set of radially-directed air passageways, and via said bores to said second set of radially-directed air passageways;
slidably moving said ISM off said FAC;
with said source of pressurized air open, slidably moving a replacement ISM to an operational location on said FAC;
closing said source of pressurized air; and
disconnecting said SRF from said EP.

16. A method for replacing an inner sleeve member (ISM), said ISM grippingly mounted on a mandrel included in a double-sleeved roller (DSR), said DSR having two ends, said two ends including a disconnectable end operationally supported by a removable support member, said DSR including an outer sleeve member (OSM) surrounding said ISM, said mandrel inclusive of a rigid sleeve-supporting member having joined thereto at said disconnectable end three termination plates having specified outer shapes, each of which outer shapes including a cylindrical portion adjacent a conically tapered portion, said termination plates including an inner termination plate (ITP), a middle termination plate (MTP), and an outer termination plate (OTP), wherein said ISM extends so as to cover said cylindrical portion of said ITP and a part of said adjacent conically tapered portion of said MTP, said OSM extending over said ITP and beyond said MTP so as to substantially cover only said cylindrical portion of said OTP, said MTP cooperatively forming with said ITP a first plurality of radial channels connectable to a source of pressurized air, said pressurized air selectably deliverable from said source to said ISM for radial expansion thereof, said first plurality of radial channels being blocked from said source by a reversible blockage, said OTP cooperatively forming with said MTP a second plurality of radial channels, said second plurality of radial channels not blocked by a blockage and thus directly connectable to said source, said pressurized air deliverable from said source to said OSM for radial expansion thereof, said method utilizing a disconnectably attachable sleeve-replacement fixture, said sleeve-replacement fixture comprising a tubular member and a mating member (MM) joined thereto, said tubular member and said MM cooperatively forming a first set of radially-directed air passageways for connection to said source of pressurized air, said MM having two faces connected by a plurality of bores leading into said first set of radially-directed air passageways, each of said tubular member and said MM having an axially thin cylindrical portion adjacent a conically tapered portion, with said conically tapered portion tapering away from said axially thin cylindrical portion, wherein in a condition with said SRF attached to said FAC, said axially thin cylindrical portions of said MM and said tubular member are closer to said other end of said SSM than are said conically tapered portions, such that said conically tapered portions taper in a direction away from said other end of said SSM, said tubular member further including a cylindrical length, said cylindrical length smoothly adjoining said conically tapered portion where said tapered portion of said tubular member has a minimum outer diameter, said cylindrical length adjoining a gradually narrowing portion of said tubular member, said gradually narrowing portion having a greatest outer diameter equal to said diameter of said cylindrical length, said method for replacing said ISM on said DSR including the steps of:
moving said removable support member away from said disconnectable end with said mandrel supported in cantilever fashion at the other end of said two ends;
opening said source of pressurized air to said second plurality of radial channels;
slidably moving said OSM off said mandrel;
closing said source of pressurized air;
removing said outer termination plate from said MTP;
unblocking said reversible blockage;
connecting said MM of said sleeve-replacement fixture to said MTP such that said MM and said MTP cooperatively create a second set of radially-directed air passageways connectable to said source of pressurized air, said bores joining in one-to-one fashion said second set of radially-directed air passageways to said first set of radially-directed air passageways;
opening said source of pressurized air, thereby supplying pressurized air to said first plurality of radial channels, to said first set of radially-directed air passageways, and via said bores to said second set of radially-directed air passageways;
slidably moving said ISM off said mandrel;
with said source of pressurized air open, slidably moving a replacement ISM to an operational location on said mandrel;
closing said source of pressurized air;
disconnecting said sleeve-replacement fixture from said MTP;
blocking, with a reversible blockage, said source of pressurized air from reaching said first plurality of radial channels;
replacing said outer termination plate thereby reforming said first plurality of radial channels;
reopening said source of pressurized air;
slidably moving an OSM over said replacement ISM to an operational location on said mandrel; and
closing said source of pressurized air.

17. A sleeve-replacement fixture (SRF) for aiding replacement of an inner sleeve member (ISM) of a double-sleeved roller (DSR) including a mandrel with a sleeve-supporting member, said ISM gripping said sleeve-supporting member of said mandrel and an outer sleeve member (OSM) surrounding said ISM, said sleeve-replacement fixture for use when attached to a fixture-accepting configuration (FAC) of said DSR, said SRF comprising:
a generally cylindrically tubular member, symmetrical about a central axis, having two ends, with one end of said tubular member terminating in a flat end surface, said tubular member having a specified outer shape about said central axis;
a mating member (MM) including a plate-like portion, having an inward face and an outward face, said inward face attached to said flat end surface of said tubular member, said outward face for attachment to said mandrel of said DSR-like portion having a specified outer shape about said central axis;
said flat end surface of said tubular member and said inward face of said plate-like portion of said MM cooperatively form a first set of radially-directed air passageways for connection to a source of pressurized air, a plurality of bores passing through said plate-like portion of said MM connecting said inward face and said outward face of said plate-like portion, said bores connecting said first set of radially-directed air passageways;
wherein, with said MM associated with said mandrel, said MM and said mandrel cooperatively create a second set of radially-directed air passageways connectable to a source of pressurized air, said bores of said MM joining said second set of radially-directed air passageways to said first set of radially-directed air passageways; and
a plurality of radial channels, associated with said mandrel, wherein with a source of pressurized air connected to said first set and said second set of radially-directed air passageways, as well as to so as to said plurality of radial channels, three sets of radially-directed air jets are formed, so that said ISM is slidably movable over said tubular member, on and off said mandrel.

18. The sleeve-replacement fixture according to claim 17, wherein said first set and said second set of radially-directed air passageways have equal numbers of radially-directed air passageways.

19. The sleeve-replacement fixture according to claim 18, wherein said specified outer shape of said MM includes an axially thin cylindrical portion adjacent a conically tapered portion, said conically tapered portion having a maximum outer diameter and a minimum outer diameter, said axially thin cylindrical portion having said maximum outer diameter, said axially thin cylindrical portion terminating at said outward face, said conically tapered portion defined by a taper angle in a range of approximately between 5°-30°.

20. The sleeve-replacement fixture according to claim 18, wherein said specified outer shape of said tubular member has a variable outer diameter perpendicular to said central axis, said variable outer diameter being maximum at said flat end surface, which variable outer diameter can decrease but not increase in a direction away from said flat end surface, said flat end surface in contact with said MM.

21. The sleeve-replacement fixture according to claim 18, wherein said specified outer shape of said tubular member includes an axially thin cylindrical portion terminating at said flat end surface, said axially thin cylindrical portion of said tubular member adjoining a conically tapered portion, said conically tapered portion of said tubular member having a maximum outer diameter and a minimum outer diameter, said axially thin cylindrical portion having said maximum outer diameter, said conically tapered portion defined by a taper angle in a range of approximately between 5°-30°.

22. The sleeve-replacement fixture according to claim 21, wherein said cylindrical length further adjoins a gradually narrowing portion of said tubular member, said gradually narrowing portion having a greatest outer diameter equal to said diameter of said cylindrical length, said gradually narrowing portion monotonically decreasing in diameter from said greatest outer diameter.

23. The sleeve-replacement fixture according to claim 18, including at least a portion with an outer coating made from a low surface energy material.

24. A fixture for a double-sleeved roller for assisting replacement of an inner sleeve member of the double-sleeved roller, said fixture comprising:
a fixture-accepting configuration, for receiving said fixture, including an end plate, and passageways for conveying jets of pressurized air to said inner sleeve member; and
a lower-surface energy-coated tubular member and a mating member cooperatively forming passageways for creating radially-directed air jets at the perimeter of said mating member; said mating member and said end plate cooperatively forming another set of passageways for similarly creating air jets utilizing a common source of pressurized air; said end plate, said mating member, and said tubular member each including a cylindrical position with an adjoining tapered portion, said respective tapered portions mutually defining a conical envelope, and said tapered portion forms a cylindrical length merging into a narrowing portion.
